(19) United States
(12) Patent Application Publication
(10) Pub. No.: US 2023/0273501 A1
(43) Pub. Date: Aug. 31, 2023

(54) OPTICAL DEVICE AND OPTICAL DETECTION SYSTEM

(71) Applicant: Panasonic Intellectual Property Management Co., Ltd., Osaka (JP)

(72) Inventors: MASAHIKO TSUKUDA, Osaka (JP); AKIRA HASHIYA, Osaka (JP); KAZUKI NAKAMURA, Osaka (JP); YASUHISA INADA, Osaka (JP)

(21) Appl. No.: 18/313,416

(22) Filed: May 8, 2023

Related U.S. Application Data
(63) Continuation of application No. PCT/JP2021/028693, filed on Aug. 3, 2021.

(30) Foreign Application Priority Data
Nov. 20, 2020 (JP) 2020-192981

(51) Int. Cl. G02F 1/295; G02F 1/13; G02F 1/01

(52) U.S. Cl. CPC G02F 1/295; G02F 1/1326; G02F 1/0142; G02F 1/0113

(57) ABSTRACT

An optical device includes a plurality of optical waveguide units arranged in a first direction. Each of the optical waveguide units includes a first mirror having a first reflecting surface, a second mirror having a second reflecting surface facing the first reflecting surface, and at least one optical waveguide region located between the first mirror and the second mirror. The distance between the first reflecting surface and the second reflecting surface is different for each of the optical waveguide units.

### BACKGROUND

### 1. Technical Field

The present disclosure relates to an optical device and an optical detection system.

### 2. Description of the Related Art

Various devices capable of scanning space with light have been proposed.

International Publication No. 2013/168266 discloses a configuration capable of scanning with light by using a driving device that rotates a mirror.

Japanese Unexamined Patent Application Publication (Translation of PCT Application) No. 2016-508235 discloses an optical phased array including a plurality of nanophotonic antenna elements arranged two-dimensionally. Each antenna element is optically coupled to a variable optical delay line (in other words, a phase shifter). In this optical phased array, a coherent light beam is guided to each antenna element through a waveguide, and the phase of the light beam is shifted by the phase shifter. This configuration enables the amplitude distribution of the far-field radiation pattern to be changed.

Japanese Unexamined Patent Application Publication No. 2013-16591 discloses a light deflection element including: a waveguide including an optical waveguide layer the inside of which guides light and first distributed Bragg reflectors formed on the upper surface and the lower surface of the optical waveguide layer; a light entrance through which light enters the waveguide; and a light exit formed in the surface of the waveguide and configured to emit the light that enters from the light entrance and is guided in the waveguide.

### SUMMARY

One non-limiting and exemplary embodiment provides a novel optical device capable of achieving scanning with light with a relatively simple configuration.

In one general aspect, the techniques disclosed here feature an optical device including a plurality of optical waveguide units arranged in a first direction, in which each of the optical waveguide units includes a first mirror having a first reflecting surface, a second mirror having a second reflecting surface facing the first reflecting surface, and at least one optical waveguide region located between the first mirror and the second mirror, and the distance between the first reflecting surface and the second reflecting surface is different for each of the optical waveguide units.

A general or concrete aspect of the present disclosure may be implemented by a system, a device, a method, an integrated circuit, a computer program, or a recording medium such as a computer readable recording disk or may be implemented by any combination of a system, a device, a method, an integrated circuit, a computer program, and a recording medium. Examples of a computer readable recording medium may include a nonvolatile recording medium such as a Compact Disc Read-Only Memory (CD-ROM). The device may include one or more devices. In the case in which the device includes two or more devices, the two or more devices may be located in one apparatus or may be separately located in two or more separate apparatuses. A “device” in the present specification and the claims denotes not only one device but may denote a system including a plurality of devices.

An aspect of the present disclosure enables one-dimensional scanning or two-dimensional scanning with light with a relatively simple configuration.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a perspective view of an optical scanning device schematically illustrating its configuration;

FIG. 2 is a diagram schematically illustrating an example of a sectional structure of one waveguide element and light propagating in it;

FIG. 3A is a sectional view of a waveguide array emitting light in the direction perpendicular to the emitting surface of the waveguide array;

FIG. 3B is a sectional view of a waveguide array emitting light in a direction different from the direction perpendicular to the emitting surface of the waveguide array;

FIG. 4 is a schematic perspective view of a waveguide array in a three-dimensional space;

FIG. 5 is a schematic diagram of a waveguide array and a phase-shifter array viewed in the direction (the Z direction) normal to the light emitting surface;

FIG. 6A is a schematic plan view of an example of an optical device according to an embodiment of the present disclosure;

FIG. 6B is a plan view of the optical device with an upper structure removed from the structure illustrated in FIG. 6A;

FIG. 6C is an enlarged plan view of part of a second optical waveguide unit illustrated in FIG. 6B;

FIG. 7A is a diagram schematically illustrating a sectional structure taken along line VIIA-VIIA in FIG. 6A before the upper structure and a lower structure illustrated in FIG. 6A are attached together;

FIG. 7B is a diagram schematically illustrating a sectional structure taken along line VIIB-VIIB in FIG. 6A before the upper structure and the lower structure illustrated in FIG. 6A are attached together;

FIG. 7C is a diagram schematically illustrating a sectional structure taken along line VIIC-VIIC in FIG. 6A before the upper structure and the lower structure illustrated in FIG. 6A are attached together;

FIG. 8A is a diagram schematically illustrating a sectional structure taken along line VIIIA-VIIIA in FIG. 6A after the upper structure and the lower structure illustrated in FIG. 6A are attached together;

FIG. 8B is a diagram schematically illustrating a sectional structure taken along line VIIIB-VIIIB in FIG. 6A after the upper structure and the lower structure illustrated in FIG. 6A are attached together;

FIG. 8C is a diagram schematically illustrating a sectional structure taken along line VIIIC-VIIIC in FIG. 6A after the upper structure and the lower structure illustrated in FIG. 6A are attached together;

FIG. 8D is an enlarged sectional view of the second optical waveguide unit illustrated in FIG. 8C;

FIG. 9 is a schematic sectional view of the optical device which is emitting light;

FIG. 10 is a graph illustrating the relationship between the emission angle of the light emitted from the optical device and the thickness of an optical waveguide region;

FIG. 11 is a schematic plan view of an example of the optical device according to the present embodiment;

FIG. 12 is a schematic perspective view of the optical device according to the present embodiment performing wide-range light scanning as an example;

FIG. 13A is a diagram for explaining an example of a manufacturing process of the upper structure;

FIG. 13B is a diagram for explaining the example of the manufacturing process of the upper structure;

FIG. 13C is a diagram for explaining the example of the manufacturing process of the upper structure;

FIG. 13D is a diagram for explaining the example of the manufacturing process of the upper structure;

FIG. 13E is a diagram for explaining the example of the manufacturing process of the upper structure;

FIG. 13F is a diagram for explaining the example of the manufacturing process of the upper structure;

FIG. 13G is a diagram for explaining the example of the manufacturing process of the upper structure;

FIG. 13H is a diagram for explaining the example of the manufacturing process of the upper structure;

FIG. 13I is a diagram for explaining the example of the manufacturing process of the upper structure;

FIG. 13J is a diagram for explaining the example of the manufacturing process of the upper structure;

FIG. 13K is a diagram for explaining the example of the manufacturing process of the upper structure;

FIG. 13L is a diagram for explaining the example of the manufacturing process of the upper structure;

FIG. 13M is a diagram for explaining the example of the manufacturing process of the upper structure;

FIG. 13N is a diagram for explaining the example of the manufacturing process of the upper structure;

FIG. 14A is a schematic plan view of an example of an optical device according to a modification example, as viewed in the Z direction;

FIG. 14B is a plan view of the optical device with an upper structure removed from the structure illustrated in FIG. 14A;

FIG. 14C is a schematic diagram illustrating the sectional structure taken along line XIVC-XIVC in FIG. 14A;

FIG. 15 is a diagram illustrating a configuration example of an optical scanning device in which the configuration illustrated in FIG. 11 is integrated into a circuit substrate;

FIG. 16 is a schematic diagram illustrating an optical scanning device emitting a light beam such as a laser to a distance to perform two-dimensional scanning; and

FIG. 17 is a block diagram illustrating a configuration example of a LiDAR system capable of generating ranging images.

### DETAILED DESCRIPTIONS

Each of the following embodiments is for showing general or concrete examples. Numerical values, shapes, materials, constituents, the arrangement positions and connection methods of the constituents, steps, and the order of the steps in the following embodiments are examples, which are not intended to limit the techniques of the present disclosure. Of the constituents in the following embodiments, the constituent not stated in the independent claims, which define the most superordinate concepts, are optional. Each figure is a schematic diagram, which is not necessarily illustrated to be precise. In each figure, substantially the same or similar constituents are denoted by the same symbols. Repetitive description will be omitted or simplified in some cases.

### UNDERLYING KNOWLEDGE FORMING BASIS OF PRESENT DISCLOSURE

Underlying knowledge forming the basis of the present disclosure will be described before an embodiment of the present disclosure.

The inventor found a problem in conventional optical scanning devices that it is difficult to scan a space with light without a complicated device structure.

For example, the technique disclosed in International Publication No. 2013/168266 requires a driving device that rotates the mirror. This makes the device structure complicated, causing a problem that the device is not robust against vibration.

In the optical phased array described in Japanese Unexamined Patent Application Publication (Translation of PCT Application) No. 2016-508235, it is necessary to split light and introduce the light into a plurality of column waveguides and a plurality of row waveguides to guide the light to the plurality of antenna elements arranged two-dimensionally. This makes wiring of the waveguides to guide the light very complicated. In addition, it is impossible to achieve wide-range two-dimensional scanning. Further, in order to change the amplitude distribution of the emitted light in the far field two-dimensionally, it is necessary to connect a phase shifter to each of the antenna elements arranged two-dimensionally and attach wiring for phase control to the phase shifters. With this configuration, the phase of the light incident on each of the antenna elements arranged two-dimensionally is changed by a different amount. This makes the configuration of the elements very complicated.

The inventor focused attention on the above problems in the conventional techniques and studied configurations to solve these problems. As a result, the inventor found that use of a waveguide element including a pair of facing mirrors and an optical waveguide layer between those mirrors can solve the above problems. One of the paired mirrors in the waveguide element has a higher light transmittance than the other and enables part of the light propagating in the optical waveguide layer to exit to the outside. The direction of the emitted light (or the emission angle) can be changed, as described later, by adjusting the refractive index or thickness of the optical waveguide layer or the wavelength of the light inputted into the optical waveguide layer. More specifically, by changing the refractive index, the thickness, or the wavelength, it is possible to change the component of the wave vector of the emitted light in the longitudinal direction of the optical waveguide layer. This enables one-dimensional scanning.

In addition, in the case of using an array of a plurality of waveguide elements, two-dimensional scanning can be achieved. More specifically, by applying appropriate phase differences to the light supplied to the plurality of waveguide elements and adjusting those phase differences, it is possible to change the direction in which the light beams emitted from the plurality of waveguide elements are intensified. Changing the phase differences changes the component of the wave vector of emitted light in the direction intersecting the longitudinal direction of the optical waveguide layers. This enables two-dimensional scanning. By applying appropriate phase differences to the light to be supplied to the plurality of optical waveguide layers and synchronously changing at least one of the refractive index of the optical waveguide layers, the thickness of the optical waveguide layers, or the wavelength by the same amount, it is possible to perform two-dimensional scanning. As described above, an embodiment of the present disclosure enables two-dimensional scanning with light with a relatively simple configuration.

In this specification, “at least one of the refractive index, the thickness, or the wavelength” denotes at least one selected from the group consisting of the refractive index of the optical waveguide layers, the thickness of the optical waveguide layers, and the wavelength of light inputted to the optical waveguide layers. One of the refractive index, the thickness, or the wavelength alone may be controlled to change the emission direction of the light. Alternatively, any two or all of these three may be controlled to change the emission direction of the light. In each embodiment, the wavelength of the light inputted to the optical waveguide layers may be controlled instead of or in addition to controlling the refractive index or the thickness.

The above basic principle can be applied not only to applications involving emitting light but also to applications involving receiving optical signals in the same or a similar manner. By changing at least one of the refractive index, the thickness, or the wavelength, it is possible to one-dimensionally change the direction of receivable light. In addition, by changing the phase differences of light by using a plurality of phase shifters connected to the respective waveguide elements arranged in one direction, it is possible to two-dimensionally change the direction of receivable light.

The optical scanning device and the optical receiving device according to an embodiment of the present disclosure may be used, for example, as an antenna in an optical detection system such as a light detection and ranging (LiDAR) system. The LiDAR system uses electromagnetic waves (visible light, infrared light, or ultraviolet light) with shorter wavelengths than those of radar systems using radio waves such as millimeter waves and thus is capable of detecting distance distribution of objects with high resolution. Such a LiDAR system may be mounted on mobile objects, for example, automobiles, unmanned aerial vehicles (UAVs, so-called drones), automated guided vehicles (AGVs), or the like, and may be used as one of collision avoidance techniques. In this specification, optical scanning devices and optical receiving devices are sometimes collectively referred to as “optical devices”. In addition, the devices used in optical scanning devices or optical receiving devices are sometimes also referred to as “optical devices”.

Hereinafter, an example of a basic configuration of an optical device and its operating principle will be described.

### Example of Basic Configuration of Optical Scanning Device

In the following, the configuration of an optical scanning device that performs two-dimensional scanning will be described as an example. However, detailed description more than necessary may be omitted. For example, detailed description of publicly known things may be omitted. This is to avoid a situation in which the following description is more redundant than necessary and to facilitate understanding by those skilled in the art.

The term “light” in the present disclosure refers to not only visible light (with wavelengths of approximately 400 nm to approximately 700 nm) but also electromagnetic waves including ultraviolet rays (with wavelengths of approximately 10 nm to approximately 400 nm) and infrared rays (with wavelengths of approximately 700 nm to approximately 1 mm). In this specification, ultraviolet rays may be referred to as “ultraviolet light”, and infrared rays may be referred to as “infrared light”.

The term “scanning” with light in the present disclosure refers to changing the direction of the light. The term “one-dimensional scanning” refers to changing the direction of light linearly in a direction intersecting the direction of the light. The term “two-dimensional scanning” refers to changing the direction of light two-dimensionally along a plane intersecting the direction of the light.

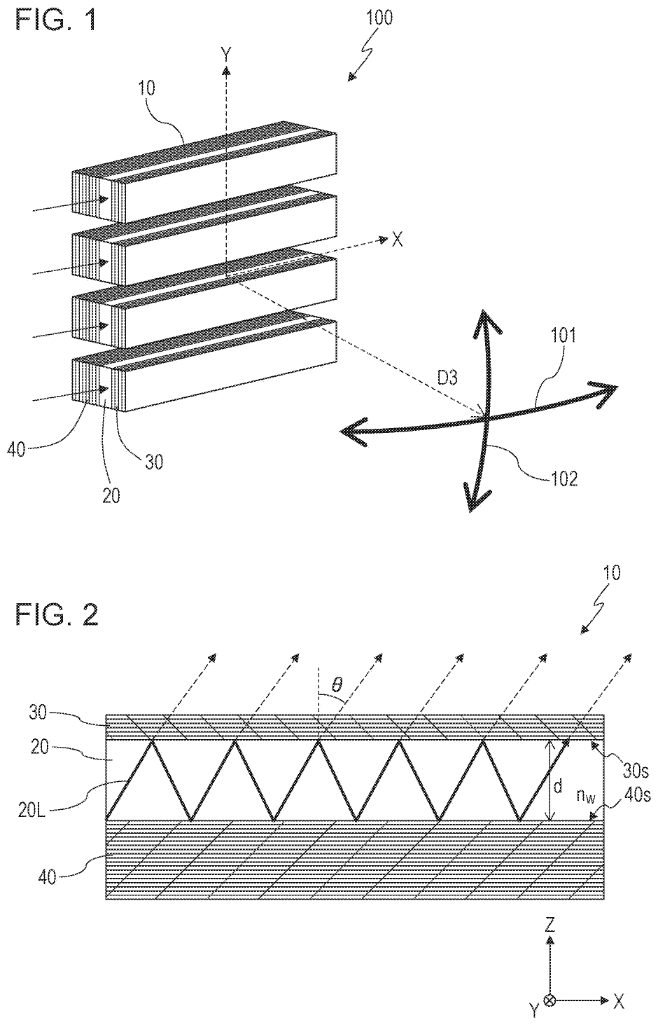

FIG. 1 is a perspective view of an optical scanning device 100 schematically illustrating its configuration. The optical scanning device 100 includes a waveguide array including a plurality of waveguide elements 10. Each of the waveguide elements 10 has a shape extending in the X direction. The plurality of waveguide elements 10 are arranged regularly in the Y direction. The plurality of waveguide elements 10 emit light in the direction D3 intersecting an imaginary plane parallel to the XY plane while propagating light in the X direction. Although the direction in which the waveguide elements 10 extend is orthogonal to the direction in which the waveguide elements 10 are arranged in the present embodiment, these directions do not have to be orthogonal to each other. Although the plurality of waveguide elements 10 are arranged at regular intervals in the Y direction in the present embodiment, the waveguide elements 10 do not necessarily have to be arranged at regular intervals.

Note that the structures illustrated in the drawings of the present disclosure are oriented in consideration of easier understanding of description and hence are not intended to limit the orientation at the time when the present embodiment is actually implemented. In addition, the shape and size of the whole or part of each structure illustrated in the drawings are also not intended to limit an actual shape and size.

Each of the waveguide elements 10 includes first and second mirrors 30 and 40 facing each other and an optical waveguide layer 20 located between the mirrors 30 and 40. Each of the mirrors 30 and 40 has a reflecting surface intersecting the direction D3 at the interface with the optical waveguide layer 20. The mirrors 30 and 40 and the optical waveguide layer 20 have shapes extending in the X direction.

Note that as described later, a plurality of first mirrors 30 of a plurality of waveguide elements 10 may be a plurality of portions of one integrated mirror. A plurality of second mirrors 40 of the plurality of waveguide elements 10 may be a plurality of portions of one integrated mirror. Further, a plurality of optical waveguide layers 20 of the plurality of waveguide elements 10 may be a plurality of portions of one integrated optical waveguide layer. A plurality of waveguides can be formed by having at least one of the following configurations: (1) each first mirror 30 is separate from the other first mirrors 30, (2) each second mirror 40 is separate from the other second mirrors 40, and (3) each optical waveguide layer 20 is separate from the other optical waveguide layers 20. The state of “being separate” refers to not only the state of being physically arranged with a space in between but also the state of being separate with a material having a different refractive index in between.

The reflecting surface of the first mirror 30 and the reflecting surface of the second mirror 40 face each other approximately in parallel. Of the two mirrors 30 and 40, at least the first mirror 30 has a property that enables part of the light propagating in the optical waveguide layer 20 to pass through. In other words, the first mirror 30 has a higher light transmittance than the second mirror 40 for the light used. This enables part of the light propagating in the optical waveguide layer 20 to be emitted through the first mirror 30 to the outside. Such mirrors 30 and 40 may be multilayer film mirrors formed of, for example, dielectric multilayer films (which may be referred to as “multilayer reflective films”).

Two-dimensional scanning with light can be achieved by controlling the phase of light inputted to each waveguide element 10 and also synchronously and simultaneously changing the refractive index of the optical waveguide layer 20, the thickness of the optical waveguide layer 20, or the wavelength of the light inputted to the optical waveguide layer 20, in each waveguide element 10.

The inventor analyzed the operating principle of the waveguide element 10 to achieve such two-dimensional scanning. As a result, the inventor has successfully achieved two-dimensional scanning with light by synchronously driving a plurality of waveguide elements 10.

As illustrated in FIG. 1, when light is inputted to each waveguide element 10, light is emitted from the emitting surface of each waveguide element 10. The emitting surface is located on the opposite side to the reflecting surface of the first mirror 30. The direction D3 of the emitted light is dependent on the refractive index and thickness of the optical waveguide layers and the wavelength of the light. In the present embodiment, at least one of the refractive index of each optical waveguide layer, the thickness of each optical waveguide layer, or the wavelength is synchronously controlled such that the light from each waveguide element 10 is emitted approximately in the same direction. This makes it possible to change the X-direction component of the wave vector of the light emitted from the plurality of waveguide elements 10. In other words, it is possible to change the direction D3 of the emitted light along the direction 101 illustrated in FIG. 1.

In addition, since the light beams from the plurality of waveguide elements 10 are emitted in the same direction, the emitted light beams interfere with one another. By controlling the phase of the light beam emitted from each waveguide element 10, it is possible to change the direction in which the light beams intensify one another by the interference. For example, in the case in which the plurality of waveguide elements 10 with the same size are arranged at regular intervals in the Y direction, the plurality of waveguide elements 10 receive input of the light beams having phases different in regular steps. By changing the phase differences, it is possible to change the Y-direction component of the wave vector of the emitted light. In other words, by changing the phase differences of light beams introduced into the plurality of waveguide elements 10, it is possible to change the direction D3, in which the emitted light beams intensify one another by the interference, along the direction 102 illustrated in FIG. 1. This enables two-dimensional scanning with light.

The operating principle of the optical scanning device 100 will be described below.

### Operating Principle of Waveguide Element

FIG. 2 is a diagram schematically illustrating an example of a sectional structure of one waveguide element 10 and light propagating in it. In FIG. 2, the direction perpendicular to the X direction and the Y direction illustrated in FIG. 1 is defined as the Z direction, and a section of the waveguide element 10 parallel to the XZ plane is schematically illustrated. In the waveguide element 10, the first mirror 30 and the second mirror 40 are located on either side of the optical waveguide layer 20. The first mirror 30 has a first reflecting surface 30s. The second mirror 40 has a second reflecting surface 40s facing the first reflecting surface 30s. Light 20L introduced at one end of the optical waveguide layer 20 in the X direction propagates in the optical waveguide layer 20 while being reflected on the first reflecting surface 30s of the first mirror 30 provided at the upper surface of the optical waveguide layer 20 (the upper surface in FIG. 2) and the second reflecting surface 40s of the second mirror 40 provided at the lower surface of the optical waveguide layer 20 (the lower surface in FIG. 2). The first mirror 30 has a higher light transmittance than the second mirror 40. Thus, it is possible to output part of the light mainly from the first mirror 30.

In a general waveguide such as an optical fiber, light propagates along a waveguide while repeating total reflection. However, in the waveguide element 10 of the present embodiment, light propagates while repeating reflection on the mirrors 30 and 40 located over and under the optical waveguide layer 20. Thus, there is no limitation on the propagation angle of light. Here, the propagation angle of light denotes the angle of incidence on the interface between the mirror 30 or 40 and the optical waveguide layer 20. Light incident on the mirror 30 or 40 at angles closer to the right angle can also be propagated. In other words, light incident on the interface at angles smaller than the critical angle for the total reflection can also be propagated. Thus, the group speed of the light in the direction of the light propagation is much lower than the velocity of light in free space. Hence, the waveguide element 10 has a characteristic in which changes in the wavelength of the light, the thickness of the optical waveguide layer 20, and the refractive index of the optical waveguide layer 20 greatly affect conditions for light propagation. Such a waveguide is referred to as the “reflective waveguide” or the “slow light waveguide”.

The emission angle θ of the light emitted from the waveguide element 10 into air is expressed by the following Expression 1.

$$sin θ = \sqrt{{n}_{w}^{2} - {( \frac{m λ}{2 d} )}^{2}} \qquad ( 1 )$$

As can be seen from Expression 1, the emission direction of the light can be changed by changing one of the wavelength λ of the light in air, the refractive index n_{w} of the optical waveguide layer 20, and the thickness d of the optical waveguide layer 20.

For example, in the case in which n_{w}=2, d=387 nm, λ=1550 nm, and m=1, the emission angle is 0°. From this state, when the refractive index is changed to n_{w}=2.2, the emission angle will be changed to approximately 66°. When the thickness is changed to d=420 nm without changing the refractive index, the emission angle will be approximately 51°. When the wavelength is changed to λ=1500 nm without changing both the refractive index and the thickness, the emission angle will be approximately 30°. As described above, the emission direction of light can be changed greatly by changing one of the wavelength λ of the light, the refractive index n_{w} of the optical waveguide layer 20, and the thickness d of the optical waveguide layer 20.

Hence, the optical scanning device 100 controls the emission direction of the light by controlling at least one of the wavelength λ of the light inputted into the optical waveguide layer 20, the refractive index n_{w} of the optical waveguide layer 20, or the thickness d of the optical waveguide layer 20. The wavelength λ of the light may be kept constant without being changed during operation. In that case, the configuration to achieve scanning with light can be simpler. The wavelength λ is not particularly limited. For example, the wavelength λ may be within a wavelength range from 400 nm to 1100 nm (specifically, from visible light to near infrared light) at which photo detectors and image sensors which detect light by general silicon (Si) absorbing light have high detection sensitivity. In another example, the wavelength λ may be within the wavelength range of near infrared light from 1260 nm to 1625 nm at which the transmission loss in optical fibers or Si waveguides is relatively small. Note that these wavelength ranges are mere examples. The wavelength range of the light used is not limited to a wavelength range of visible light or infrared light and may be, for example, a wavelength range of ultraviolet light.

To change the direction of emitted light, the optical scanning device 100 may include a first adjustment element that changes at least one of the refractive index of the optical waveguide layer 20, the thickness of the optical waveguide layer 20, or the wavelength, in each waveguide element 10.

As has been described above, in the waveguide element 10, the emission direction of the light can be changed greatly by changing at least one of the refractive index n_{w} of the optical waveguide layer 20, the thickness d of the optical waveguide layer 20, or the wavelength λ. With this configuration, it is possible to change the emission angle of the light emitted from the mirror 30 in a direction along the waveguide element 10. Such one-dimensional scanning can be achieved by using at least one waveguide element 10.

To adjust the refractive index of at least part of the optical waveguide layer 20, the optical waveguide layer 20 may include a liquid crystal material or an electro-optic material. Pared electrodes may be located on either side of the optical waveguide layer 20. By applying a voltage to the paired electrodes, it is possible to change the refractive index of the optical waveguide layer 20.

To adjust the thickness of the optical waveguide layer 20, for example, at least one actuator may be connected to at least one of the mirror 30 or 40. By changing the distance between the mirrors 30 and 40 with the at least one actuator, it is possible to change the thickness of the optical waveguide layer 20. If the optical waveguide layer 20 is made of a liquid, it is easy to change the thickness of the optical waveguide layer 20.

### Operating Principle of Two-Dimensional Scanning

In the waveguide array including the plurality of waveguide elements 10 arranged in one direction, the emission direction of the light changes due to interference of the light emitted from each waveguide element 10. By adjusting the phase of the light supplied to each waveguide element 10, it is possible to change the emission direction of the light. The following describes the principle.

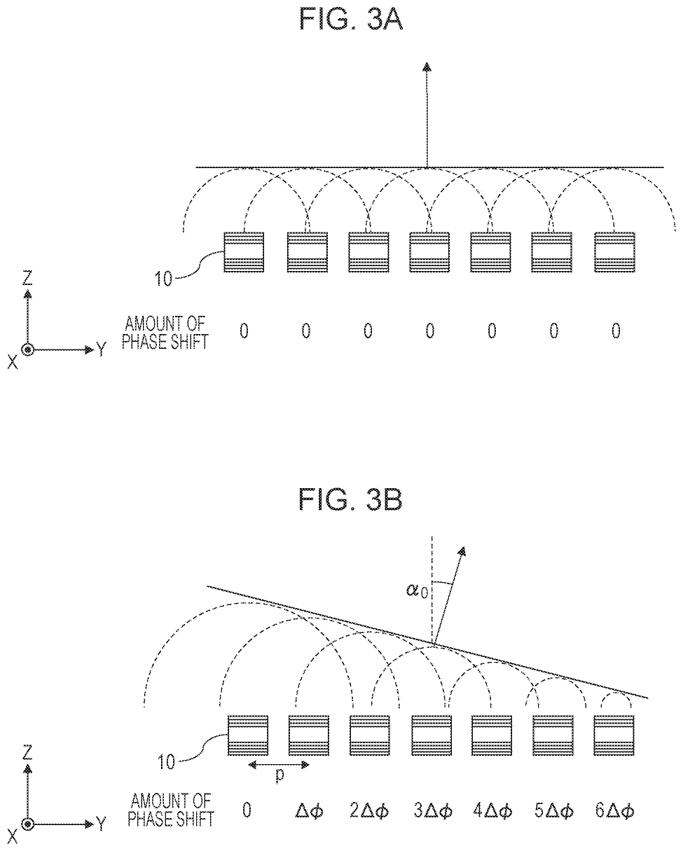

FIG. 3A is a sectional view of a waveguide array emitting light in the direction perpendicular to the emitting surface of the waveguide array. In FIG. 3A, the amount of phase shift of the light propagating in each waveguide element 10 is indicated. Here, the amount of phase shift is a value with respect to the phase of the light propagating the leftmost waveguide element 10. The waveguide array in the present embodiment includes a plurality of waveguide elements 10 arranged at regular intervals. In FIG. 3A, the circular arcs of dashed lines indicate wavefronts of the light emitted from the waveguide elements 10. The straight line indicates the wavefront formed by interference of light. The arrow indicates the direction of the light emitted from the waveguide array (in other words, the direction of the wave vector). In the example of FIG. 3A, the phase of the light propagating in the optical waveguide layer 20 in each waveguide element 10 is the same. In this case, light is emitted in the direction (the Z direction) perpendicular to both the arrangement direction of the waveguide elements 10 (the Y direction) and the extending direction of the optical waveguide layers 20 (the X direction).

FIG. 3B is a sectional view of a waveguide array emitting light in a direction different from the direction perpendicular to the emitting surface of the waveguide array. In the example illustrated in FIG. 3B, the phases of the light propagating in the optical waveguide layers 20 in the plurality of waveguide elements 10 are different in the arrangement direction in regular steps of a certain amount (Δφ). In this case, light is emitted in a direction different from the Z direction. By changing this Δφ, it is possible to change the Y-direction component of the wave vector of the light. In the case in which p is the distance between the centers of adjoining two waveguide elements 10, the emission angle α₀ of the light is expressed by the following Expression 2.

$$sin {α}_{0} = \frac{Δϕλ}{2 π p} \qquad ( 2 )$$

In the example illustrated in FIG. 2, the emission direction of the light is parallel to the XZ plane. Specifically, α₀=0°. In the example illustrated in FIGS. 3A and 3B, the direction of the light emitted from the optical scanning device 100 is parallel to the YZ plane. Specifically, θ=0°. However, in general, the direction of the light emitted from the optical scanning device 100 is not parallel to either the XZ plane or the YZ plane. Specifically, θ≠0° and α₀≠0°.

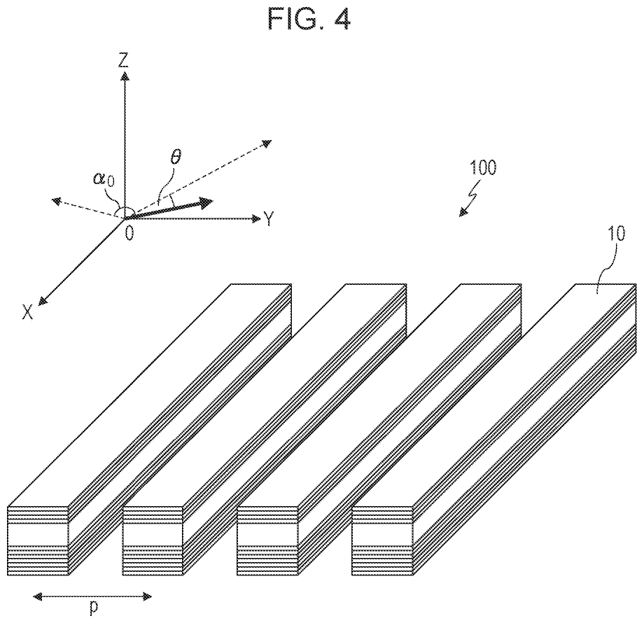

FIG. 4 is a schematic perspective view of a waveguide array in a three-dimensional space. The thick arrow in FIG. 4 indicates the direction of the light emitted from the optical scanning device 100. The symbol θ indicates the angle between the emission direction of the light and the YZ plane. The angle θ satisfies Expression 1. The angle α₀ is the angle between the emission direction of the light and the XZ plane. The angle α₀ satisfies Expression 2.

### Phase Control of Light to be Introduced to Waveguide Array

To control the phase of the light emitted from each waveguide element 10, for example, a phase shifter for changing the phase of light is provided upstream of the stage in which light is introduced to the waveguide element 10. The optical scanning device 100 includes a plurality of phase shifters connected to the respective waveguide elements 10 and a second adjustment element for adjusting the phase of the light propagating in each phase shifter. Each phase shifter includes a waveguide connected directly or via another waveguide to the optical waveguide layer 20 of the corresponding one of the waveguide elements 10. The second adjustment element changes the difference between the phases of the light propagating from the plurality of phase shifters to the plurality of waveguide elements 10 to change the direction D3 of the light emitted from the plurality of waveguide elements 10. In the following description, the plurality of arranged phase shifters are referred to as the “phase-shifter array” as with the waveguide array.

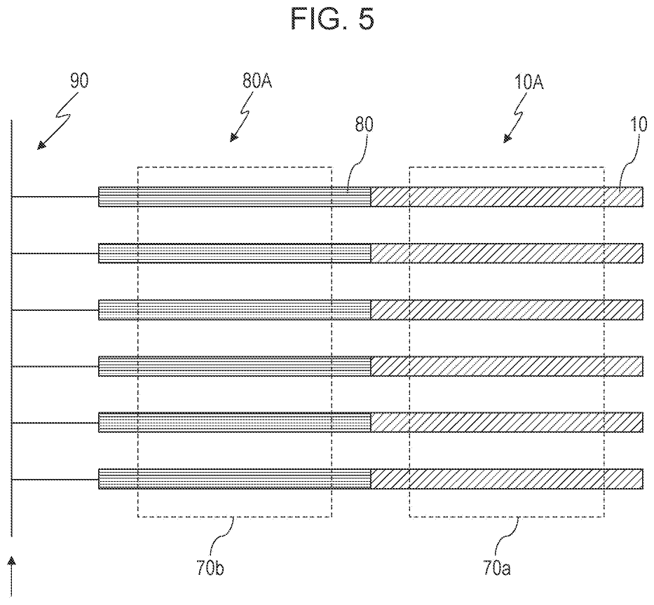

FIG. 5 is a schematic diagram of a waveguide array 10A and a phase-shifter array 80A viewed in the direction (the Z direction) normal to the light emitting surface. In the example illustrated in FIG. 5, all of the phase shifters 80 have the same propagation characteristics, and all of the waveguide elements 10 have the same propagation characteristics. Each of the phase shifters 80 and each of the waveguide elements 10 may have the same length or a different length. In the case in which all of the phase shifters 80 have the same length, for example, the amount of phase shift can be adjusted by the drive voltage. Alternatively, in the case of a structure in which the lengths of the phase shifters 80 are different in regular steps, phase shifts in regular steps can be achieved by the same drive voltage. This optical scanning device 100 further includes an optical splitter 90 that splits light and supplies the split light to the plurality of phase shifters 80, a first drive circuit 70a that drives each waveguide element 10, and a second drive circuit 70b that drives each phase shifter 80. The straight arrow in FIG. 5 indicates input of light. Controlling independently the first and second drive circuits 70a and 70b provided separately enables two-dimensional scanning. In this example, the first drive circuit 70a functions as one element of a first adjustment element, and the second drive circuit 70b functions as one element of a second adjustment element.

The first drive circuit 70a changes at least one of the refractive index or the thickness of the optical waveguide layer 20 in each waveguide element 10 to change the angle of the light emitted from each optical waveguide layer 20. The second drive circuit 70b changes the refractive index of the optical waveguide layer 20 in each phase shifter 80 to change the phase of light propagating inside each optical waveguide layer 20. The optical splitter 90 may be a waveguide in which light propagates by total reflection or may be a reflective waveguide the same as or similar to the waveguide element 10.

Note that the phase of each light beam split in the optical splitter 90 may be controlled before the light beam is introduced to the phase shifter 80. This phase control may employ, for example, a passive phase control structure in which the lengths of the waveguides to the phase shifters 80 are adjusted. Alternatively, phase shifters that can be controlled by electrical signals and that have functions the same as or similar to those of the phase shifter 80 may be used. With these methods, for example, the phase may be adjusted before the light is introduced to the phase shifters 80 so that light with the same phase is supplied to all of the phase shifters 80. Such adjustment simplifies control of each phase shifter 80 by the second drive circuit 70b.

An optical device having a configuration the same as or similar to that of the optical scanning device 100 described above can be used also as an optical receiving device. Details of operating principles, operating methods, and the like of optical devices are disclosed in U.S. Patent Application Publication No. 2018/0224709. The entire disclosure of this document is incorporated in the present specification.

### Manufacturing of Optical Device by Attaching Upper and Lower Structures Together

The optical device 100 may be manufactured, for example, by attaching an upper structure including the first mirror 30 and a lower structure including the second mirror 40 together. For the attachment, a sealing member, for example, an ultraviolet curing resin, a thermosetting resin, or the like, may be used. A region corresponding to the foregoing optical waveguide layer is formed between the upper structure and the lower structure. This region is referred to as the “optical waveguide region”. To enable scanning with light by voltage application, the optical waveguide region may include, for example, a liquid crystal material. To inject a liquid crystal material into the optical device 100, for example, vacuum encapsulation may be used. A liquid crystal material may be injected into the space surrounded by the above sealing member. Such a method prevents vacuum leak during injection of the liquid crystal material.

In this manufacturing process by attaching a lower structure and an upper structure together, it is possible that the distance between the upper structure and the lower structure is not as designed and an error can occur, depending on the accuracy of the attachment. Due to the error, it is possible that a manufactured optical device cannot provide performance as designed, for example, on the emission angle and/or the intensity of emitted light.

To solve this issue, the optical device according to the embodiment of the present disclosure includes the following configuration. The optical device includes a plurality of optical waveguide units. Each of the optical waveguide units includes a first mirror 30, a second mirror 40, and at least one optical waveguide region located between the first and second mirrors 30 and 40. The distance between the reflecting surface 30s of the first mirror 30 and the reflecting surface 40s of the second mirror 40 is different for each optical waveguide unit. The distance (hereinafter also referred to as the “mirror distance”) between the reflecting surface 30s of the first mirror 30 and the reflecting surface 40s of the second mirror 40 in each optical waveguide unit may be designed such that the distance is slightly different for each optical waveguide unit. For example, the optical waveguide units may be designed such that the design values of the mirror distances are different for each optical waveguide units in regular steps of Δd. As described later in detail, Δd is set to an appropriate value according to the number of optical waveguide units and the maximum value of the allowable error. Such design increases the possibility that even if the mirror distance of an optical waveguide unit is out of the allowable range due to a manufacturing error, the mirror distance of at least another one of the optical waveguide units is within the allowable range. Of the plurality of optical waveguide units, the optical waveguide units whose mirror distances are within the allowable range are selectively used, so that light can be emitted from the optical device 100 as designed.

Hereinafter, overall configurations of an optical device and an optical detection system according to an embodiment of the present disclosure will be described.

An optical device according to a first item includes a plurality of optical waveguide units arranged in a first direction. Each of the optical waveguide units includes a first mirror having a first reflecting surface, a second mirror having a second reflecting surface facing the first reflecting surface, and at least one optical waveguide region located between the first mirror and the second mirror. The distance between the first reflecting surface and the second reflecting surface is different for each of the optical waveguide units.

This optical device increases the possibility that even if a manufacturing error occurs, the distance between the first mirror and the second mirror will be within the allowable range in at least one of the optical waveguide units.

In the optical device according to the first item, an optical device according to a second item is in which at least one of the optical waveguide units includes at least one optical input waveguide that is optically connected to the optical waveguide region and that inputs light to the optical waveguide region.

In this optical device, it is possible to input light to the optical waveguide region of each of the optical waveguide units.

In the optical device according to the second item, an optical device according to a third item is in which the optical input waveguide is connected to the optical waveguide region via a mode converter.

In this optical device, the mode converter increases the efficiency in optical coupling from the optical input waveguide to the optical waveguide region.

In the optical device according to the third item, an optical device according to a fourth item is in which the mode converter includes a grating. The grating has a structure the refractive index of which varies periodically along a second direction intersecting the first direction.

In this optical device, appropriate design of the grating configuration increases the efficiency in optical coupling from the optical input waveguide to the optical waveguide region.

In the optical device according to the third or fourth item, an optical device according to a fifth item is in which the efficiency in optical coupling from the optical input waveguide in the at least one of the optical waveguide units to the optical waveguide region via the mode converter is higher than or equal to 80%.

This optical device enables light to be coupled with high efficiency to the optical waveguide region of at least one of the optical waveguide units.

In the optical device according to the fifth item, an optical device according to a sixth item is in which the efficiency in optical coupling in an optical waveguide unit adjoining the at least one of the optical waveguide units is lower than 80%.

This optical device enables light to be coupled with high efficiency to the optical waveguide region of only some of the optical waveguide units of the plurality of optical waveguide units.

In the optical device according to any one of the first to sixth items, an optical device according to a seventh item is in which the distance between the first reflecting surface and the second reflecting surface varies monotonously along the first direction.

In this optical device, the mirror with a multi-step structure enables the distance between the first mirror and the second mirror to differ for each optical waveguide unit.

In the optical device according to the seventh item, an optical device according to an eighth item is in which the distance between the first reflecting surface and the second reflecting surface varies in regular steps along the first direction.

For this optical device, it is easy to fabricate a mirror having a multi-step structure.

In the optical device according to any one of the first to eighth items, an optical device according to a ninth item is in which the first mirror has a higher transmittance than the second mirror.

In this optical device, it is possible to emit part of the light propagating in the optical waveguide region to the outside via the first mirror.

In the optical device according to the ninth item, an optical device according to a tenth item is in which each of the optical waveguide units includes a first electrode and a second electrode, and a liquid crystal material between the first mirror and the second mirror. The optical waveguide region is filled with the liquid crystal material, and the voltage applied between the first electrode and the second electrode is changed to change the direction of light emitted from the optical waveguide region via the first mirror or the incident direction of light taken into the optical waveguide region via the first mirror.

In this optical device, by applying a voltage between the first electrode and the second electrode, it is possible to change the direction of the light emitted via the first mirror or to change the incident direction of the light taken into the optical waveguide region via the first mirror.

In the optical device according to any one of the first to tenth items, an optical device according to an eleventh item further includes: a first structure including the first mirror included in each of the optical waveguide units; a second structure including the second mirror included in each of the optical waveguide units; and at least one support member that is located between the first structure and the second structure and defines the distance between the first reflecting surface and the second reflecting surface.

In this optical device, since the first structure and the second structure are attached together via the support member, it is possible to make the first reflecting surface and the second reflecting surface approximately parallel.

In the optical device according to the eleventh item, an optical device according to a twelfth item is in which the support member is formed of an elastic material.

In this optical device, it is possible to make the first reflecting surface and the second reflecting surface approximately parallel by using the support member made of an elastic material.

In the optical device according to any one of the first to twelfth items, an optical device according to a thirteenth item further includes an optical switch capable of selectively supplying light to the optical waveguide region included in at least one of the optical waveguide units.

In this optical device, it is possible to selectively use at least one of the optical waveguide units.

In the optical device according to any one of the first to thirteenth items, an optical device according to a fourteenth item is in which, of the plurality of optical waveguide units, only part of the optical waveguide units are supplied with light and the other optical waveguide units are not supplied with light.

In this optical device, only some of the optical waveguide units are used.

In the optical device according to the fourteenth item, an optical device according to a fifteenth item is in which the efficiency in optical coupling to the optical waveguide region in the part of the optical waveguide units is higher than or equal to 80%.

In this optical device, it is possible to use only the optical waveguide units having an efficiency higher than or equal to 80% in optical coupling to the optical waveguide region.

An optical detection system according to a sixteenth item includes: the optical device according to any one of the first to fifteenth items; an optical detector that detects light emitted from the optical device and reflected on a target object; and a signal processing circuit that generates distance distribution data, according to output from the optical detector.

In this optical detection system, it is possible to generate distance images.

In the present disclosure, all or some of the circuits, the units, the devices, the members, and the portions, or all or some of the functional blocks in the block diagram may be implemented by, for example, one or a plurality of electronic circuits including a semiconductor device, a semiconductor integrated circuit (IC), or a large-scale integration (LSI). The LSI or the IC may be integrated into one chip or may have a configuration of a combination of chips. For example, the functional blocks other than memory elements may be integrated into one chip. Here, the electronic circuits are referred to as an LSI or an IC; however, the name changes depending on the degree of integration. The electronic circuits may be a chip called a system LSI, a very-large-scale integration (VLSI), or an ultra-large-scale-integration (ULSI). A field-programmable gate array (FPGA) which is programed after the LSI is manufactured or a reconfigurable logic device which can be reconfigured in the connection relationship inside the LSI or in which the circuit sections inside the LSI can be set up may be used for the same purpose.

In addition, the functions or the operation of all or some of the circuits, the units, the devices, the members, and the portions may be implemented by software processing. In this case, the software is recorded in one or a plurality of non-transitory recording media such as ROMs, optical discs, and hard-disk drives, and when the software is executed by a processor, the function defined by the software is executed by the processor and peripheral devices. The system or device may include one or a plurality of non-transitory recording media in which the software is recorded, a processor, and a necessary hardware device, for example, an interface.

### EMBODIMENT

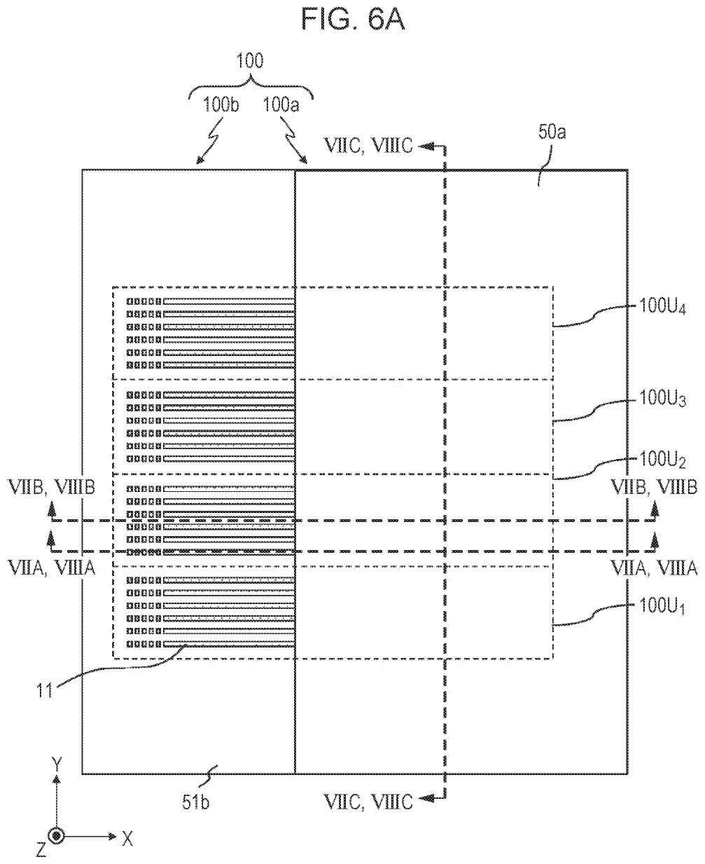

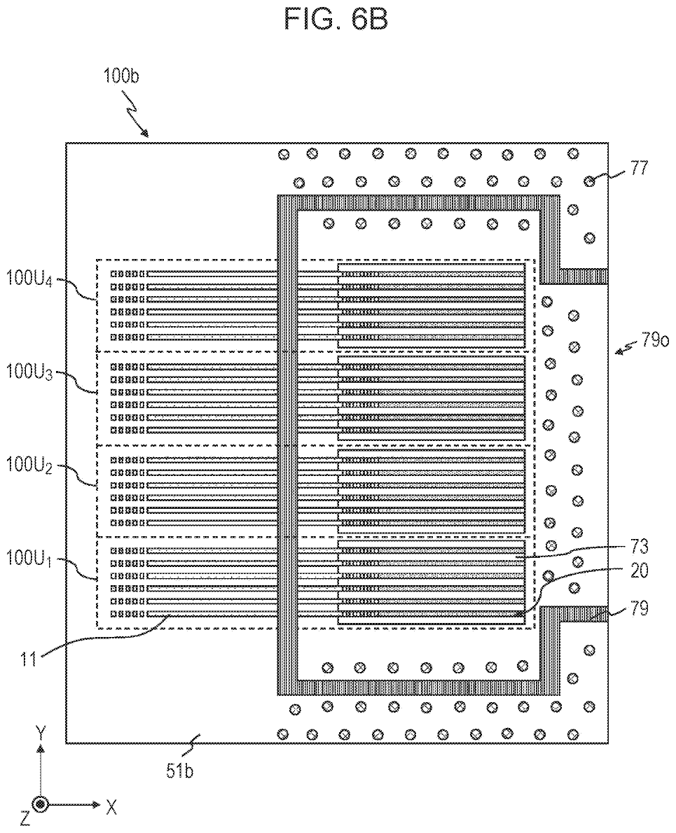

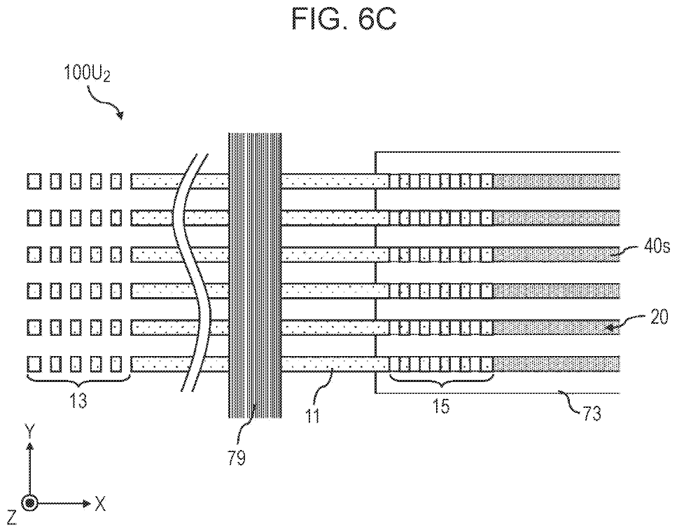

FIG. 6A is a schematic plan view of an example of an optical device 100 according to an embodiment of the present disclosure. This optical device 100 includes an upper structure 100a and a lower structure 100b. FIG. 6B is a plan view of the optical device 100 with the upper structure 100a removed from the structure illustrated in FIG. 6A.

In this specification, the side on which the upper structure 100a is located is referred to as the “upper portion”, and the side on which the lower structure 100b is located is referred to as the “lower portion”. The terms the “upper portion” and the “lower portion” are used for the convenience of explanation, and thus they are not intended to limit the orientation of the optical device 100 in use. Regardless of these terms, the orientation of the optical device 100 may be determined as appropriate depending on the application. In this specification, the upper structure 100a is also referred to as the “first structure”, and the lower structure 100b is also referred to as the “second structure”.

As illustrated in FIGS. 6A and 6B, the optical device 100 of the present embodiment includes a first optical waveguide unit 100U₁, a second optical waveguide unit 100U₂, a third optical waveguide unit 100U₃, and a fourth optical waveguide unit 100U₄. In the following, these optical waveguide units are also referred to as the “optical waveguide units 100U” when they are not distinguished one from the others. The first to fourth optical waveguide units 100U₁ to 100U₄ are located in the regions surrounded by dashed lines illustrated in FIGS. 6A and 6B. The number of optical waveguide units 100U is not limited to four and may be any number larger than or equal to two.

FIG. 6C is an enlarged plan view of part of the second optical waveguide unit 100U₂ illustrated in FIG. 6B.

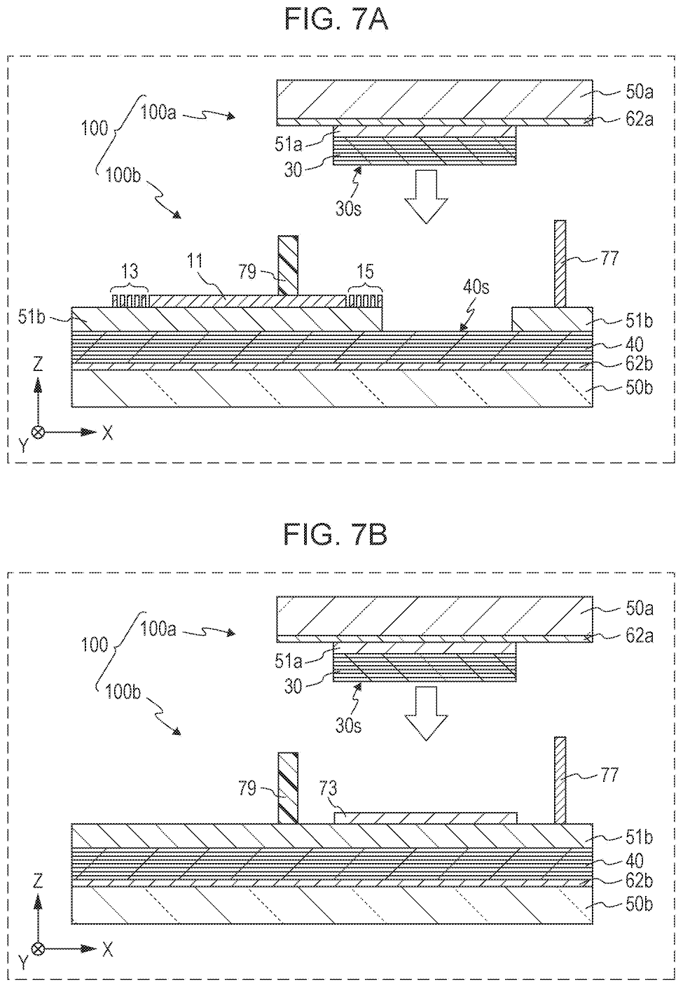

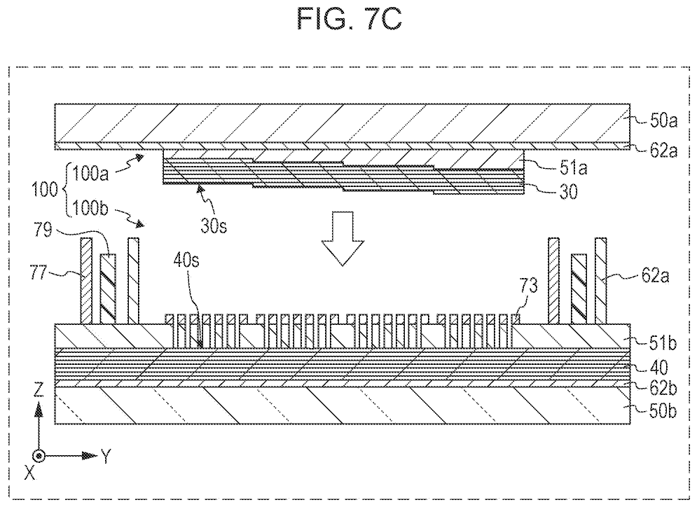

FIGS. 7A, 7B, and 7C are schematic diagrams illustrating sectional structures of the optical device 100 before the upper structure 100a and the lower structure 100b illustrated in FIG. 6A are attached together. The sections illustrated in FIGS. 7A to 7C correspond to the section taken along line VIIA-VIIA, the section taken along line VIIB-VIIB, and the section taken along line VIIC-VIIC, respectively, in FIG. 6A. The down arrows illustrated in FIG. 7A to FIG. 7C show that the upper structure 100a is attached onto the lower structure 100b.

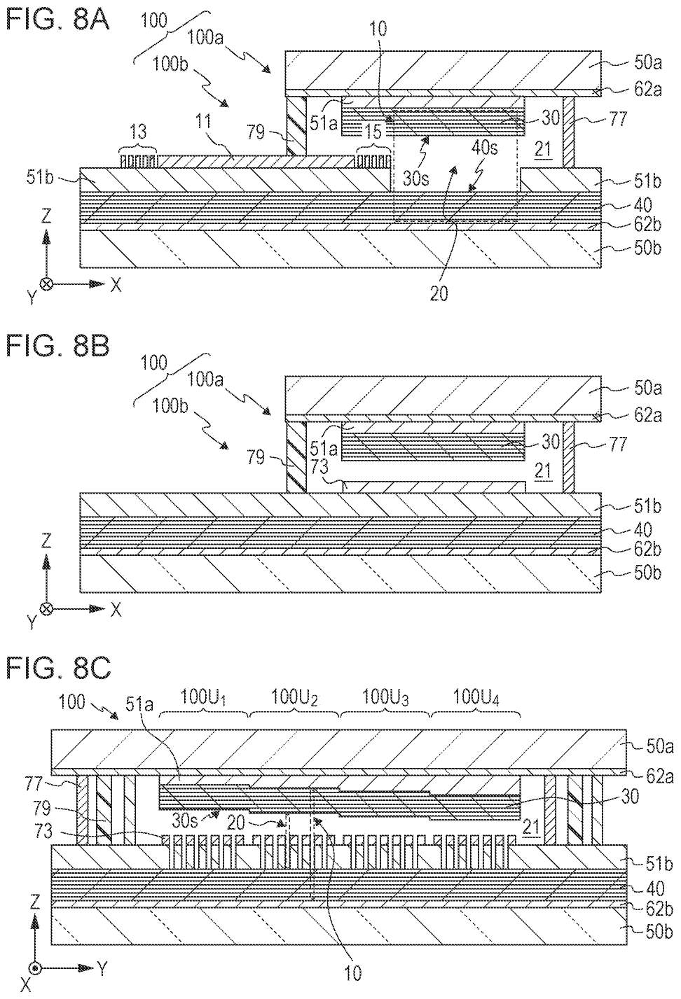

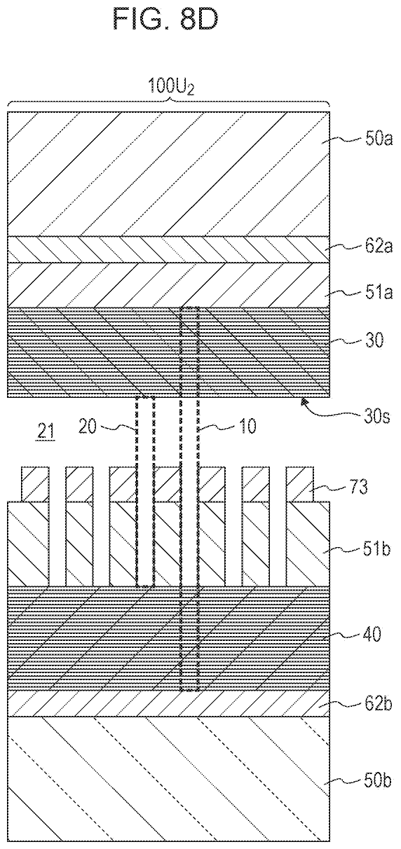

FIGS. 8A to 8C are diagrams schematically illustrating sectional structures of the optical device 100 after the upper structure 100a and the lower structure 100b are attached together. FIGS. 8A to 8C illustrate the structures at the section taken along line VIIIA-VIIIA, the section taken along line VIIIB-VIIIB, and the section taken along line VIIIC-VIIIC, respectively, in FIG. 6A. FIG. 8D is an enlarged sectional view of the second optical waveguide unit 100U₂ illustrated in FIG. 8C.

As illustrated in FIGS. 7A to 8D, the upper structure 100a includes a first substrate 50a, a first electrode 62a, a dielectric layer 51a, and a first mirror 30. The first electrode 62a, the first dielectric layer 51a, and the first mirror 30 are provided in this order on the first substrate 50a. As illustrated in FIG. 8C, the dielectric layer 51a and the first mirror 30 have a multi-step structure having a step at each boundary between the optical waveguide units 100U.

The lower structure 100b includes a second substrate 50b, a second electrode 62b, a second mirror 40, a second dielectric layer 51b, a plurality of partition walls 73, a plurality of elastic spacers 77, a sealing member 79, and a plurality of optical waveguides 11. The second electrode 62b is provided on the second substrate 50b. The second mirror 40 is provided on the second electrode 62b. The reflecting surface 40s of the second mirror 40 faces the reflecting surface 30s of the first mirror 30. The second dielectric layer 51b is provided on the second mirror 40. Part of the second dielectric layer 51b is removed, and part of the reflecting surface 40s of the mirror 40 is exposed. The plurality of partition walls 73, the plurality of elastic spacers 77, the sealing member 79, and the plurality of optical waveguides 11 are provided on the second dielectric layer 51b.

The upper structure 100a and the lower structure 100b can be fabricated by using, for example, a semiconductor process. The semiconductor process may include, for example, film formation by sputtering, vapor deposition, or the like, photolithography, and etching.

As illustrated in FIGS. 7A to 7C, the upper structure 100a and the lower structure 100b are attached together in a manufacturing process of the optical device 100. In addition, as illustrated in FIGS. 8A to 8C, the space between the upper structure 100a and the lower structure 100b is filled with a liquid crystal material 21. The optical device 100 is manufactured as described above. Part of the space filled with the liquid crystal material 21 serves as optical waveguide regions 20. As described later, the plurality of elastic spacers 77 serve to make the first substrate 50a and the second substrate 50b parallel with a specified distance in between in the attachment step. However, the distance between the substrate 50a and the substrate 50b can have an error. Due to this error, there is a possibility that the distance between the first mirror 30 and the second mirror 40 in each optical waveguide unit 100U can be out of the allowable range. In that case, the direction or intensity of the light emitted from the optical waveguide units 100U will be shifted from the design values, and this will prevent a desired performance.

As illustrated in FIGS. 8C and 8D, a plurality of optical waveguide regions 20 are formed between the reflecting surface 30s of the first mirror 30 and the reflecting surface 40s of the second mirror 40. These optical waveguide regions 20 are partitioned by the partition walls 73. The dimension in the Z direction, in other words, the thickness, of each optical waveguide region 20 is equal to the distance between the reflecting surface 30s of the first mirror 30 and the reflecting surface 40s of the second mirror 40. The dimension in the Y direction, in other words, the width, of each optical waveguide region 20 is equal to the distance between the side surfaces of the two partition walls 73 located on either side of the optical waveguide region 20. The portions of the first mirror 30 that overlap the optical waveguide regions 20 as viewed in the Z direction, the portions of the second mirror 40 that overlap the optical waveguide regions 20 as viewed in the Z direction, and the optical waveguide regions 20 form optical waveguides. The optical waveguides function as the foregoing waveguide elements 10, in other words, slow light waveguides. In the following description, these optical waveguides are referred to as the “optical waveguides 10”.

FIGS. 6C and 8D schematically illustrate the structure of the second optical waveguide unit 100U₂ as an example. The other optical waveguide units 100U₁, 100U₃, and 100U₄ have the same or similar structures, except that the mirror distances are different. As illustrated in FIG. 8D, each optical waveguide unit 100U includes the first substrate 50a, the first electrode 62a, the first dielectric layer 51a, the first mirror 30, the second substrate 50b, the second electrode 62b, the second mirror 40, the second dielectric layer 51b, a plurality of optical waveguide regions 20, and a plurality of partition walls 73. As illustrated in FIG. 6C, each optical waveguide unit 100U further includes a plurality of optical waveguides 11 connected to the plurality of optical waveguide regions 20. Note that the first mirror 30 included in each optical waveguide unit 100U is part of the first mirror 30 included in the optical device 100. The same is true of the second mirror 40, the first electrode 62a, the second electrode 62b, the first substrate 50a, the second substrate 50b, the first dielectric layer 51a, and the second dielectric layer 51b included in each optical waveguide unit 100U. The plurality of optical waveguide regions 20 included in each optical waveguide unit 100U are part of the plurality of optical waveguide regions 20 included in the optical device 100. The same is true of the plurality of partition walls 73 and the plurality of optical waveguides 11 included in each optical waveguide unit 100U.

In the optical device 100 of the present embodiment, the distance between the reflecting surface 30s of the mirror 30 and the reflecting surface 40s of the mirror 40, in other words, the mirror distance, is different for each optical waveguide unit 100U. As illustrated in FIG. 8C, the mirror distance of the first optical waveguide unit 100U₁ is largest, and the mirror distance gradually decreases in the order of the second optical waveguide unit 100U₂, the third optical waveguide unit 100U₃, and the fourth optical waveguide unit 100U₄. The plurality of steps are formed in the first dielectric layer 51a such that the structure above can be achieved. These steps form the same or similar steps on the surfaces of the first mirror 30, and this enables the structure in which the mirror distance is different for each optical waveguide unit 100U. The design values of the mirror distances of the optical waveguide units 100U may be set to be different at regular steps of, for example, a value Δd. As will be described in detail, Δd is set to an appropriate value according to the number of optical waveguide units and the maximum value of the allowable error. With such a design, even if an error occurs in the distance between the first substrate 50a and the second substrate 50b, this design increases the possibility that the distance between the reflecting surface 30s of the first mirror 30 and the reflecting surface 40s of the second mirror 40 can be within the allowable range in at least one of the optical waveguide units 100U. By selectively using the optical waveguide unit the mirror distance of which is within the allowable range, of the plurality of optical waveguide units 100U, it is possible to emit light from the optical device 100 as designed, in terms of, for example, the emission angle and/or the intensity of the emitted light.

In the present embodiment, only part of the optical waveguide units selected out of the plurality of optical waveguide units 100U are supplied with light and the other optical waveguide units are not supplied with light, in some cases. The part of the optical waveguide units are, for example, the ones in which the efficiency in optical coupling to the optical waveguide regions 20 is higher than or equal to 80%. Alternatively, the part of the optical waveguide units are the ones in which the scannable angle width is larger than or equal to 30°. The optical waveguide units 100U that are not provided with light are dummies, which are not used. The optical waveguide units 100U not provided with light are disconnected from the light source that inputs light.

Note that the plurality of optical waveguide units 100U in the present embodiment are connected to one another, forming a single structure. The structure of the plurality of optical waveguide units 100U is not limited to the one above, and the plurality of optical waveguide units 100U may be physically separated. Although the plurality of optical waveguide units 100U in the present embodiment are arranged in the Y direction without a distance in between as illustrated in FIG. 8C, the plurality of optical waveguide units 100U may be arranged with a distance in between. The dimension of each optical waveguide unit 100U in the Y direction may be uniform or nonuniform. The number of optical waveguide units 100U is not limited to four and may be any number larger or equal to two. The number of optical waveguide units 100U may be, for example, larger than or equal to two and smaller than or equal to ten.

### Details of Constituents of Optical Device 100

Hereinafter, the configuration of the optical device 100 according to the present embodiment will be described in more detail. From now on, the terms such as “first” and “second” may be omitted in the following description.

Of the substrates 50a and 50b, the substrate from which light is emitted has light transmission properties. Both the substrates 50a and 50b may have light transmission properties. Similarly, of the electrodes 62a and 62b, the electrode on the side where light is emitted has light transmission properties. Both the electrodes 62a and 62b may have light transmission properties. At least one of the electrode 62a or 62b is made of, for example, a transparent electrode. Of the dielectric layers 51a and 51b, the dielectric layer on the side where light is emitted has light transmission properties. Both the dielectric layers 51a and 51b may have light transmission properties. In the example illustrated in FIG. 8C, light is emitted from the plurality of optical waveguides 10 via the dielectric layer 51a, the electrode 62a, and the substrate 50a in the upper structure 100a.

The plurality of partition walls 73 are provided on the dielectric layer 51b. The plurality of partition walls 73 are arranged in the Y direction. Each of the partition walls 73 has a structure extending in the X direction. The portions of the dielectric layer 51b located between the plurality of partition walls 73 as viewed in the Z direction are removed. As a result, a plurality of portions of the reflecting surface 40s of the mirror 40 are exposed. The plurality of the exposed portions are arranged in the Y direction. Each of the exposed portions has a shape extending in the X direction. As illustrated in FIG. 8C, the portions of the dielectric layer 51b that are not removed and the partition walls 73 immediately above the not-removed-portions of the dielectric layer 51b form protrusions extending in the X direction. Thus, a plurality of protrusions arranged in the Y direction are formed on the mirror 40. Although the upper surfaces of the protrusions are not in contact with the reflecting surface of the mirror 30 in the example illustrated in FIG. 8C, the upper surfaces of the protrusions may be in contact with the reflecting surface of the mirror 30. A plurality of recesses are formed between the plurality of protrusions. The recesses also have a structure extending in the X direction. The depth of each recess, in other words, the height of the protrusions on either side of each recess, may be, for example, larger than or equal to 1 μm and smaller than or equal to 10 μm. Here, the depth of the recess and the height of the protrusion denote each dimension measured in the Z direction in the figures.

The plurality of optical waveguide regions 20 are defined in the regions where the plurality of recesses are located as viewed in the Z direction. An optical waveguide region 20 is surrounded by the reflecting surface 30s of the mirror 30, the reflecting surface 40s of the mirror 40, two adjoining protrusions, and the spaces between the two adjoining protrusions and the mirror 30. In a configuration in which the upper surface of the protrusions are in contact with the reflecting surface 30s of the mirror 30, an optical waveguide region 20 would be surrounded by the reflecting surface 30s of the mirror 30, the reflecting surface 40s of the mirror 40, and two adjoining protrusions. The optical waveguide region 20 includes the liquid crystal material 21. Although the liquid crystal material 21 is used in the present embodiment, another kind of a dielectric material, for example, an electro-optic material, the refractive index of which can be changed by applying a voltage may be used. The reflecting surface 30s and/or the reflecting surface 40s may have an alignment film that defines the alignment direction of the liquid crystal material. In the example illustrated in FIG. 8D, the six optical waveguide regions 20 are arranged in the Y direction in the second optical waveguide unit 100U₂. The number of optical waveguide regions 20 in each optical waveguide unit 100U is not limited to six and may be any number larger than or equal to one. The number of optical waveguide regions 20 in each optical waveguide unit 100U may be, for example, larger than or equal to 1 and smaller than or equal to 128.

The optical waveguide region 20 has a higher refractive index than the partition walls 73 and the dielectric layer 51b. The light propagating in the optical waveguide region 20 does not leak into the protrusions on either side of the optical waveguide region 20. This is because the light propagating in the optical waveguide region 20 is totally reflected on the interfaces between the optical waveguide region 20 and the protrusions. The region where the protrusions exist and the region between the protrusions and the mirror 30 can be referred to as the “non-waveguide regions”. The plurality of optical waveguide regions 20 and the plurality of non-waveguide regions are alternately arranged in the Y direction between the mirrors 30 and 40. With this configuration, the plurality of optical waveguides 10 arranged in the Y direction are formed.

The electrodes 62a and 62b face each other, and the optical waveguide region 20 is indirectly between the electrodes 62a and 62b. The term “being indirectly between” denotes being between the electrodes 62a and 62b via another member. In the present embodiment, the mirrors 30 and 40 are located between the electrodes 62a and 62b. The positional relationship between the electrode 62a and the mirror 30 may be opposite. In that case, the electrode 62a may have an alignment film on its surface. Similarly, the positional relationship between the electrode 62b and the mirror 40 may be opposite. By adjusting the voltage applied between the electrodes 62a and 62b, it is possible to adjust the refractive index of the liquid crystal material 21. By changing the voltage, the emission angle of the light emitted from the optical waveguide 10 to the outside is changed.

The plurality of elastic spacers 77 are formed of an elastic material and located around the plurality of optical waveguides 10. In the example illustrated in FIG. 6B, the plurality of elastic spacers 77 in the form of pillars are located two-dimensionally. This may be orderly or periodic arrangement or may be disorderly arrangement. In the example illustrated in FIG. 6B, the elastic spacers 77 are located both inside and outside the region surrounded by the sealing member 79. The elastic spacers 77 may be provided in only one of the inside or the outside of this region. As described above, the elastic spacers 77 are located at least one of the inside or the outside of this region. Some of the elastic spacers 77 may be provided in the optical waveguide layers 20. The number of elastic spacers 77 may be any number larger than or equal to one. The elastic spacers 77 may have one continuous shape inside and/or outside the region surrounded by the sealing member 79. This shape may be, for example, in the form of a straight line, a curved line, a wavy line, or a zigzag line as viewed in the Z direction.

As illustrated in FIGS. 7A to 7C, in the state before the upper structure 100a and the lower structure 100b are attached together, the dimension of the elastic spacers 77 in the Z direction is larger than the dimension of the sealing member 79 in the Z direction. Thus, when the upper structure 100a and the lower structure 100b are attached together, the electrode 62a of the upper structure 100a comes into contact first with the elastic spacers 77 of the lower structure 100b.

Elastic deformation occurs in the elastic spacers 77. When a force is applied to an elastic member, and a strain occurs, the elastic modulus is defined by dividing the applied force by the strain that occurred. The elastic spacer 77 has, for example, a lower elastic modulus than the mirror 30 and the partition wall 73. In other words, the elastic spacer 77 is easier to deform than the mirror 30 and the partition wall 73. When the upper structure 100a and the lower structure 100b are attached together with a certain pressure, the elastic spacers 77 are compressed while acting like springs. This makes the substrate 50a and the substrate 50b approximately parallel. The plurality of elastic spacers 77 are held between the upper structure 100a and the lower structure 100b and define the distance between the reflecting surface 30s and the reflecting surface 40s. In the example illustrated in FIG. 8C, the elastic spacers 77 are held between the electrode 62a included in the upper structure 100a and the dielectric layer 51b included in the lower structure 100b. In the present specification, the elastic spacers 77 are also referred to as the “support members”.

Without the elastic spacers 77, for example, the electrode 62a would come into contact first with the sealing member 79, and the contact point could function as a fulcrum, so that the upper structure 100a could incline relative to the lower structure 100b. As a result, there is a possibility that the substrate 50a could not be parallel to the substrate 50b.

With the elastic spacers 77, the substrate 50a and the substrate 50b can be approximately parallel; however, the distance between the substrate 50a and the substrate 50b can have an error because of the following reasons. One conceivable reason is that the dimensions of the elastic spacers 77 in the Z direction before attachment can have variation. Another conceivable reason is that the pressure for attaching the upper structure 100a and the lower structure 100b together can vary, and this can cause a variation in the amount of deformation in the elastic spacers 77.

The sealing member 79 fixes the distance between the upper structure 100a and the lower structure 100b. As illustrated in FIG. 6B, the sealing member 79 surrounds the plurality of optical waveguide regions 20 and the plurality of partition walls 73 as viewed in the Z direction. The sealing member 79 includes a portion extending in the Y direction and portions extending in the X direction from either end of the portion extending in the Y direction. The sealing member 79 is provided on the dielectric layer 51b such that the portion extending in the Y direction passes over the plurality of optical waveguides 11. The upper surface of the sealing member 79 is parallel to the XY plane. The dimension in the Z direction of the portion of the sealing member 79 located immediately above the dielectric layer 51b is larger than the total thickness (in other words, the total dimension in the Z direction) of the partition wall 73, the mirror 30, and the dielectric layer 51a as illustrated in FIG. 8B. The sealing member 79 may be formed of, for example, a light curing resin such as an ultraviolet curing resin or a thermosetting resin. Since the sealing member 79 is expandable before curing, the upper structure 100a and the lower structure 100b can be attached together without a gap in between. After the upper structure 100a and the lower structure 100b are attached together, the sealing member 79 is cured by irradiation of light or heating. The material of the sealing member 79 does not have to be a light curing resin or a thermosetting resin as long as the material is capable of keeping the distance between the substrate 50a and the substrate 50b for a long period of time. The liquid crystal material 21 may be injected into the space surrounded by the sealing member 79 by, for example, vacuum injection. By injecting the liquid crystal material 21 into the space, it is possible to prevent vacuum leak when injecting the liquid crystal material 21.

The plurality of optical waveguides 11 are connected to the respective optical waveguide regions 20. Light is supplied to the optical waveguide regions 20 through the optical waveguides 11. In the example illustrated in FIG. 8A, the optical waveguides 11 are located on the dielectric layer 51b. By adjusting the dimension of the dielectric layer 51b in the Z direction, it is possible to efficiently connect the light propagating in the optical waveguides 11 to the optical waveguides 10. The dimension of the dielectric layer 51b in the Z direction may be adjusted, for example, such that the optical waveguides 11 will be located near the center of the optical waveguide regions 20 in the Z direction. The optical waveguides 11 propagate light by total reflection. Hence, the optical waveguides 11 have a higher refractive index than the dielectric layer 51b. In the example illustrated in FIGS. 6A and 6B, six optical waveguides 11 are arranged in the Y direction in each optical waveguide unit 100U. The number of optical waveguides 11 in each optical waveguide unit 100U is not limited to six and may be any number larger than or equal to one. The number of optical waveguides 11 in each optical waveguide unit 100U may be, for example, larger than or equal to 1 and smaller than or equal to 128. Note that the optical waveguides 11 are not limited to total reflection waveguides and may be slow light waveguides.

As illustrated in FIG. 6C, each optical waveguide 11 of each optical waveguide unit 100U has a distal end portion located between two adjoining partition walls of the plurality of partition walls 73. Each optical waveguide 11 has a grating 15 at the distal end portion. The grating 15 has a periodic structure in which the refractive index of the surface varies periodically along the X direction. The grating 15 may include, for example, grooves periodically arranged in the X direction. The propagation constant of the light propagating in the optical waveguide 11 differs from the propagation constant of the light propagating in the optical waveguide 10. The grating 15 converts part of the light propagating in the optical waveguide 11 into diffracted light. The propagation constant of the diffracted light is equal to the value obtained by shifting the propagation constant of the light propagating in the optical waveguide 11 by the reciprocal lattice of the periodic structure, in other words, by the reciprocal of the period multiplied by 2π. When the propagation constant of the diffracted light agrees with the propagation constant of the light propagating in the optical waveguide region 20, the light propagating in the optical waveguide 11 is coupled to the optical waveguide region 20 efficiently. Even if these two propagation constants do not completely agree with each other, if the difference between these two propagation constants can be decreased, the optical coupling efficiency from the optical waveguide 11 to the optical waveguide region 20 via the grating 15 will be improved. The optical coupling efficiency depends on the period, duty ratio, and depth of the grooves included in the grating 15. In the optical waveguide 11, the distal end portion including the grating 15 may be considered to be another constituent. In the present specification, any constituent including the grating 15 that improves the optical coupling efficiency is referred to as a “mode converter”. Such a configuration may be, for example, a tapered structure the width of which decreases in the distal end portion toward the optical waveguide region 20. The optical waveguide 11 is connected to the optical waveguide region 20 via the mode converter.

Each optical waveguide 11 has a portion that fully overlaps the substrate 50b but does not overlap the substrate 50a as viewed in the Z direction. As illustrated in FIG. 6C, each optical waveguide 11 may include a grating 13 in the non-overlapped portion. In the example illustrated in FIG. 6C, each optical waveguide 11 includes the grating 13 in the distal end portion opposite to the distal end portion where the grating 15 is provided. In the optical waveguide 11, the portion including the grating 13 may be considered to be another constituent. The light inputted via the grating 13 can be coupled to the optical waveguide 11 with higher efficiency. The optical waveguide 11 may include a portion that fully overlaps the substrate 50b but does not overlap the substrate 50a as in the present embodiment or may include a portion that does not overlap either the substrate 50a or the substrate 50b. As described above, the optical waveguide 11 may include a portion that does not overlap at least one of the substrate 50a or the substrate 50b as viewed in the direction perpendicular to the surface of each substrate. Note that without using the optical waveguides 11, light may be directly inputted from the light source into end portions of the optical waveguide regions 20.

### Thickness Design Range of Optical Waveguide Region 20

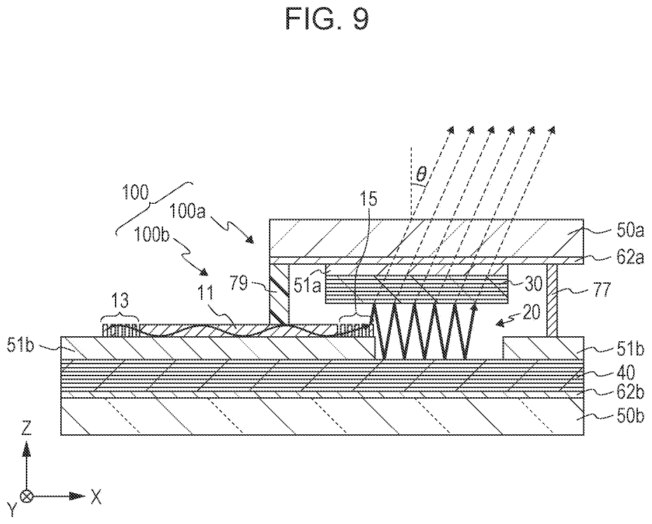

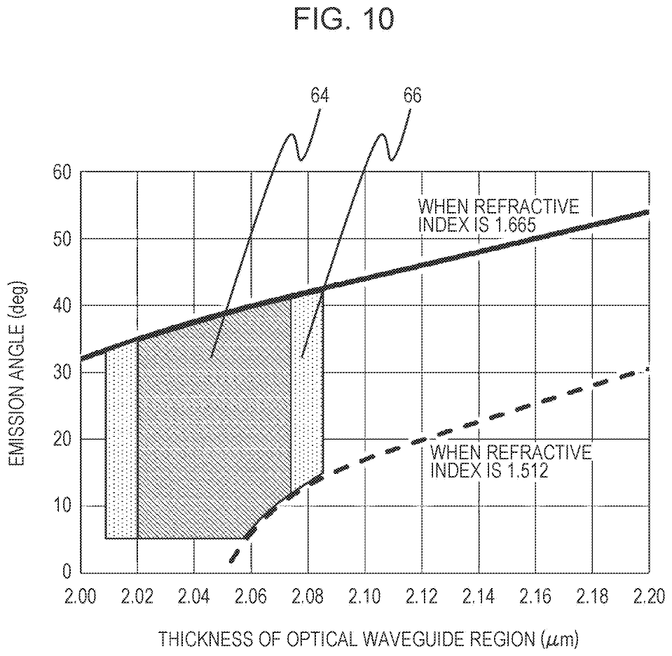

The following describes the relationship between the emission angle of the light emitted from the optical device 100 and the thickness of the optical waveguide region 20 and the relationship between the efficiency in optical coupling from the optical waveguide 11 to the optical waveguide region 20 and the thickness of the optical waveguide region 20, with reference to FIGS. 9 and 10.

FIG. 9 is a schematic sectional view of the optical device 100 which is emitting light. As illustrated in FIG. 9, the light inputted via the grating 13 propagates through the optical waveguide 11 and is inputted into the optical waveguide region 20 via the grating 15. The inputted light is emitted to the outside via the upper structure 100a. In the example illustrated in FIG. 9, the emission direction of the light is parallel to the XZ plane, and the emission angle is θ.

FIG. 10 is a graph illustrating the relationship between the emission angle of the light emitted from the optical device 100 and the thickness of the optical waveguide region 20. The thickness of the optical waveguide region 20 is the distance between the first mirror 30 and the second mirror 40. The optical waveguide region 20 has a plurality of waveguide modes. FIG. 10 illustrates an example of the relationship between the emission angle and the thickness in the seventh waveguide mode. In the example illustrated in FIG. 10, the ordinary refractive index of the liquid crystal material forming the optical waveguide region 20 is 1.512, and the extraordinary refractive index is 1.665. In this case, the refractive index of the optical waveguide region 20 changes within the range of 1.512 to 1.665 by applying voltage to the liquid crystal material. In the example illustrated in FIG. 10, the wavelength of the light propagating in the optical waveguide region 20 is 940 nm. The solid line in FIG. 10 indicates the case in which the refractive index of the optical waveguide region 20 is the upper limit value 1.665, and the dashed line in FIG. 10 indicates the case in which the refractive index of the optical waveguide region 20 is the lower limit value 1.512. The angle range between the solid line and the dashed line in FIG. 10 shows the scannable emission angle range. The scannable emission-angle range is dependent on the thickness of the optical waveguide region 20. For example, in the case in which the thickness of the optical waveguide region 20 is 2.10 μm, the scannable emission-angle range is from 17° to 44°. In this case, the scannable angle width is 27°. The larger the scannable angle width, the more applications the optical device 100 can be used for. If the optical device 100 is applied to, for example, an in-vehicle LiDAR system, it is desirable that the scannable angle width be larger than or equal to 30°. In the example illustrated in FIG. 10, in the case in which the refractive index of the optical waveguide region 20 is the lower limit value 1.512, if the thickness of the optical waveguide region 20 is smaller than or equal to 2.05 μm, light will not be emitted. By making the refractive index of the optical waveguide region 20 larger than 1.512, it is possible to emit light even if the thickness is smaller than or equal to 2.05 μm. However, when the emission angle is near 0°, the propagation length of the light propagating in the optical waveguide region 20 is short. With the short propagation length, the dimension in the X direction of the region of the outer surface of the mirror 30 from which light is emitted is short. For this reason, there is a possibility that emitted light can be excessively spread out at long distances. Hence, to prevent emitted light from excessively spreading out at long distances, in the optical device 100 according to the present embodiment, the refractive index of the optical waveguide region 20 is adjusted so that the emission angle will not be smaller than 5°. In the example illustrated in FIG. 10, in the case in which the thickness of the optical waveguide region 20 is larger than or equal to 2.020 μm and smaller than or equal to 2.075 m, the scannable angle width can be larger than or equal to 30°. The range for this case is indicated as the region 64 in FIG. 10. Note that depending on the purpose and application, the scannable angle width does not necessarily have to be larger than or equal to 30°.

The thickness of the optical waveguide region 20 affects the efficiency in optical coupling from the optical waveguide 11 to the optical waveguide region 20. To couple light efficiently from the optical waveguide 11 to the optical waveguide region 20, it is desirable that the optical coupling efficiency be, for example, larger than or equal to 80%. In the example illustrated in FIG. 9, the grating 15 functioning as a mode converter has, for example, grooves having a period of 670 nm, a duty ratio of 1:1, and a depth of 45 nm. In FIG. 10, the region 66 indicates a thickness range (from 2.010 μm to 2.085 μm) of the optical waveguide region 20 in which the optical coupling efficiency can be larger than or equal to 80%. The scannable angle width is not always larger than or equal to 30° in the region 66. The thickness range of the optical waveguide region 20 in the region 66 includes the thickness range of the optical waveguide region 20 in the region 64. In the region where the region 64 overlaps the region 66, the optical coupling efficiency is larger than or equal to 80%, and also the scannable angle width is larger than or equal to 30°. In the example illustrated in FIG. 10, when the scannable angle width larger than or equal to 30° is achieved, the optical coupling ratio larger than or equal to 80% can also be achieved. Note that depending on the purpose and application, the optical coupling efficiency does not necessarily have to be larger than or equal to 80%.

To achieve an optical coupling efficiency larger than or equal to 80% or a scannable angle width larger than or equal to 30° in addition to an optical coupling efficiency larger than or equal to 80%, the thickness of the optical waveguide region 20 has an allowable range such as the lateral width of the region 64 or the region 66. When the upper structure 100a and the lower structure 100b are attached together, there is a possibility that the distance between the substrate 50a and the substrate 50b can have a manufacturing error. It is not always easy to make the manufacturing error within the allowable range of the thickness of the optical waveguide region 20. To solve this issue, in the optical device 100 according to the present embodiment, the distance between the reflecting surface 30s of the mirror 30 and the reflecting surface 40s of the mirror 40 is different for each optical waveguide unit 100U as illustrated in FIG. 8C. The distance between the reflecting surface 30s and the reflecting surface 40s is approximately uniform within each optical waveguide unit 100U. In the example illustrated in FIG. 8C, the distance between the reflecting surface 30s and the reflecting surface 40s in the plurality of optical waveguide units 100U varies monotonously in regular steps along the Y direction. In the example illustrated in FIG. 8C, the distance between the reflecting surface 30s and the reflecting surface 40s in the first optical unit region 100U₁ is larger than that in the second optical unit region 100U₂. The distance between the reflecting surface 30s and the reflecting surface 40s in the second optical unit region 100U₂ is larger than that in the third optical unit region 100U₃. The distance between the reflecting surface 30s and the reflecting surface 40s in the third optical unit region 100U₃ is larger than that in the fourth optical unit region 100U₄.

The distance between the reflecting surface 30s and the reflecting surface 40s, in other words, the mirror distance, in the plurality of optical waveguide units 100U does not necessarily have to change in regular steps along the Y direction. The mirror distance also does not have to change monotonously along the Y direction. In other words, the distance between the reflecting surface 30s and the reflecting surface 40s in the plurality of optical waveguide units 100U may first increase then decrease along the Y direction or may first decrease then increase along the Y direction.

In the example illustrated in FIG. 10, the thickness of the optical waveguide region 20 that can achieve an optical coupling efficiency larger than or equal to 80% is larger than or equal to 2.010 μm and smaller than or equal to 2.085 μm, and the allowable range of the thickness is 75 nm. In this case, the design center value of the thickness of the optical waveguide region 20 is set to 2.0475 μm, and each unit may be designed such that this design center value is equal to the intermediate value between the design value of the mirror distance in the second optical waveguide unit 100U₂ and the design value of the mirror distance in the third optical waveguide unit 100U₃. In addition, the plurality of optical waveguide units 100U may be designed such that the mirror distance varies, for example, in regular steps of the allowable range of 75 nm along the Y direction. In this case, the design value of the thickness of the optical waveguide region 20 in the first optical waveguide unit 100U₁ is 2.160 μm, the design value of the thickness of the optical waveguide region 20 in the second optical waveguide unit 100U₂ is 2.085 μm, the design value of the thickness of the optical waveguide region 20 in the third optical waveguide unit 100U₃ is 2.010 μm, and the design value of the thickness of the optical waveguide region 20 in the fourth optical waveguide unit 100U₄ is 1.935 μm. With this configuration, even if an error in the distance between the substrate 50a and the substrate 50b is rather large, it is possible to achieve an optical coupling efficiency larger than or equal to 80% in one of the first to fourth optical waveguide units 100U₁ to 100U₄. Which optical waveguide unit 100U achieved an optical coupling efficiency larger than or equal to 80% can be determined by, for example, testing conducted after the optical device 100 is manufactured. The optical waveguide unit that achieved an optical coupling efficiency larger than or equal to 80% is selectively used for scanning with light.

In the above example, if the absolute value of the error in the distance between the substrate 50a and the substrate 50b is larger than 0 nm and smaller than or equal to 75 nm, an optical coupling efficiency larger than or equal to 80% is achieved in the second optical waveguide unit 100U₂ or the third optical waveguide unit 100U₃. If the absolute value of the error in the distance between the substrate 50a and the substrate 50b is larger than 75 nm and smaller than or equal to 150 nm, an optical coupling efficiency larger than or equal to 80% is achieved in the first optical waveguide unit 100U₁ or the fourth optical waveguide unit 100U₄. In other words, if the absolute value of the error in the distance between the substrate 50a and the substrate 50b is larger than 0 nm and smaller than or equal to 150 nm, an optical coupling efficiency larger than or equal to 80% can be achieved in one of the first to fourth optical waveguide units 100U₁ to 100U₄. If the optical coupling efficiency in an optical waveguide unit is larger than or equal to 80%, the optical coupling efficiency in the adjoining optical waveguide unit(s) is smaller than 80%.

In addition to an optical coupling efficiency larger than or equal to 80%, a scannable angle width larger than or equal to 30° can also be achieved. In the example illustrated in FIG. 10, the thickness of the optical waveguide region 20 that can achieve, in addition to an optical coupling efficiency larger than or equal to 80%, a scannable angle width larger than or equal to 30° is larger than or equal to 2.020 μm and smaller than or equal to 2.075 μm, and the allowable range of the thickness is 55 nm. In this case, the design center value of the thickness of the optical waveguide region 20 is set to 2.0475 μm, and each unit may be designed such that the design center value is equal to the intermediate value between the design value of the mirror distance in the second optical waveguide unit 100U₂ and the design value of the mirror distance in the third optical waveguide unit 100U₃. In addition, the plurality of optical waveguide units 100U may be designed such that the mirror distance varies, for example, in regular steps of the allowable range of 55 nm along the Y direction. With this configuration, even if an error in the distance between the substrate 50a and the substrate 50b is rather large, it is possible to achieve not only an optical coupling efficiency larger than or equal to 80% but also a scannable angle width larger than or equal to 30° in one of the first to fourth optical waveguide units 100U₁ to 100U₄. The optical waveguide unit that achieved not only an optical coupling efficiency larger than or equal to 80% but also a scannable angle width larger than or equal to 30° is selectively used for scanning with light.

In the foregoing example, in the case in which the number of optical waveguide units 100U is four, the allowable upper limit value of the absolute value of the error in the distance between the substrate 50a and the substrate 50b is twice the above allowable range. In the case in which the number of optical waveguide units 100U is six, the allowable upper limit value is three times the above allowable range. In the case in which the number of optical waveguide units 100U is 2N (N is an integer), the allowable upper limit value is N times the above allowable range. By increasing the number of optical waveguide units 100U, it is possible to increase the allowable upper limit value.

In the foregoing example, an optical coupling efficiency larger than or equal to 80% or both an optical coupling efficiency larger than or equal to 80% and a scannable angle width larger than or equal to 30° is achieved in only one of the optical waveguide units 100U. Depending on the purpose and application, such performance may be achieved in two or more of the optical waveguide units. In the optical device 100 according to the present embodiment, even if the manufacturing error caused in the distance between the substrate 50a and the substrate 50b is rather large, such performance can be achieved in at least one of the optical waveguide units.

Although the design center value of the thickness of the optical waveguide region 20 is set to the intermediate value between the design value of the mirror distance in the second optical waveguide unit 100U₂ and the design value of the mirror distance in the third optical waveguide unit 100U₃ in the foregoing example, the present disclosure is not limited to the foregoing example. In the foregoing example, the difference in the thickness of the optical waveguide region 20 between two adjoining optical waveguide units is designed to be equal to the above allowable range. The difference in the thickness of the optical waveguide region 20 between two adjoining optical waveguide units may be designed to be smaller than the above allowable range or larger than the above allowable range.

### Selective Light Input to Plurality of Optical Waveguide Units

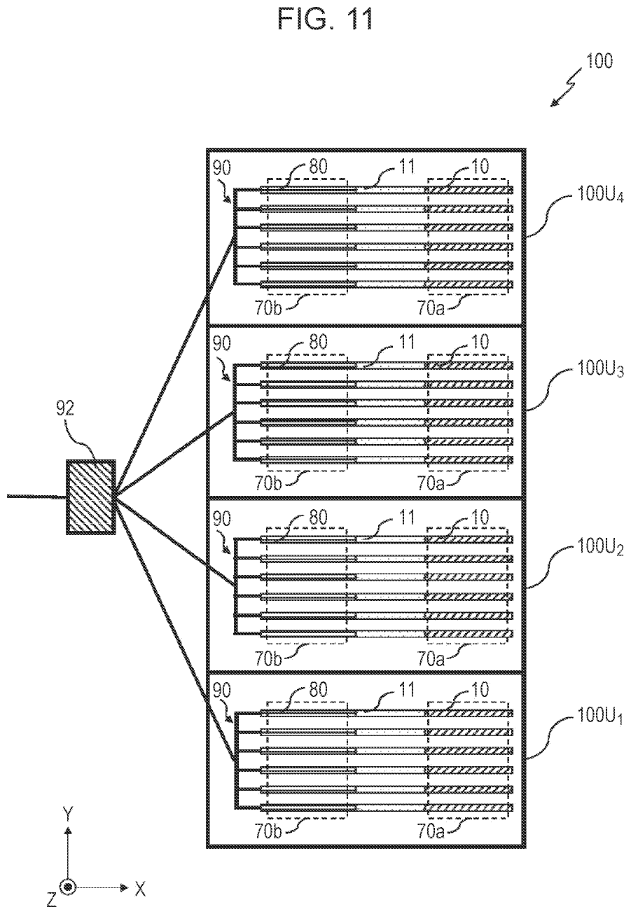

Next, with reference to FIGS. 11 and 12, a description will be given of an example of a configuration to selectively supply light to at least one of the optical waveguide units 100U included in the optical device 100 according to the present embodiment.

FIG. 11 is a schematic plan view of an example of the optical device 100 according to the present embodiment. In the example illustrated in FIG. 11, the optical device 100 includes, in each optical waveguide unit 100U, a plurality of optical waveguides 10, a plurality of optical waveguides 11 connected to the respective optical waveguides 10, a plurality of phase shifters 80 connected to the respective optical waveguides 11, a first drive circuit 70a that drives the plurality of optical waveguides 10, and a second drive circuit 70b that drives the plurality of optical waveguides 11. In FIG. 11, of the constituents illustrated in FIGS. 8A to 8C, illustration of the constituents except the plurality of optical waveguides 10 and the plurality of optical waveguides 11 is omitted. In each optical waveguide unit 100U illustrated in FIG. 11, by driving the plurality of optical waveguides 10 with the first drive circuit 70a, the X-direction components of the wave vectors of emitted light beams change. By driving the plurality of phase shifters 80 with the second drive circuit 70b, the Y-direction components of the wave vectors of the emitted light beams change.

In the example illustrated in FIG. 11, the optical device 100 includes a plurality of optical splitters 90 and an optical switch 92. Each optical splitter 90 splits light and supplies the split light to the plurality of phase shifters 80 included in one optical waveguide unit 100U. The optical switch 92 selectively supplies the light inputted from a light source (not-illustrated) to at least one of the optical splitters 90. This configuration enables the optical switch 92 to supply inputted light selectively to the plurality of optical waveguide regions 20 included in at least one of the optical waveguide units 100U.

The optical switch 92 supplies light to only part of the optical waveguide units of the plurality of optical waveguide units 100U and does not supply light to the other optical waveguide units. The part of the optical waveguide units are, for example, the ones in which the efficiency in optical coupling to the optical waveguide region 20 is larger than or equal to 80%. Alternatively, the part of the optical waveguide units are the ones in which the scannable angle width is larger than or equal to 30°. The optical waveguide units 100U that are not provided with light are dummies, which are not used. The optical waveguide units 100U not provided with light are disconnected from the light source that inputs light into the optical switch 92.

FIG. 12 is a schematic perspective view of the optical device 100 according to the present embodiment which is performing wide-range light scanning as an example. As illustrated in FIG. 12, the scanning ranges of the light emitted from the plurality of optical waveguide units 100U are different from one another. Each sector shape with a double arrow illustrated in FIG. 12 indicates the scanning range of the light emitted from the corresponding optical waveguide unit 100U. In the example illustrated in FIG. 12, assume that a scannable angle width larger than or equal to 30° is achieved in the third optical waveguide unit 100U₃ of the first to fourth optical waveguide units 100U₁ to 100U₄. A scannable angle width larger than or equal to 30° is not achieved in the optical waveguide units except the third optical waveguide unit 100U₃, but those optical waveguide units are capable of emitting light at emission angles different from those of the third optical waveguide unit 100U₃. Hence, by using not only the third optical waveguide unit 100U₃ but also the other optical waveguide units, it is possible to scan at emission angles in a wider range as can be seen in the plurality of scanning ranges illustrated in FIG. 12. The optical switch 92 illustrated in FIG. 11 enables the light indicated by the black arrow in FIG. 12 to be selectively inputted to the first to fourth optical waveguide units 100U₁ to 100U₄. Light may be inputted in the order of the first to fourth optical waveguide units 100U₁ to 100U₄, or light may be inputted in an irregular order.

### Manufacturing Process of Upper Structure 100a

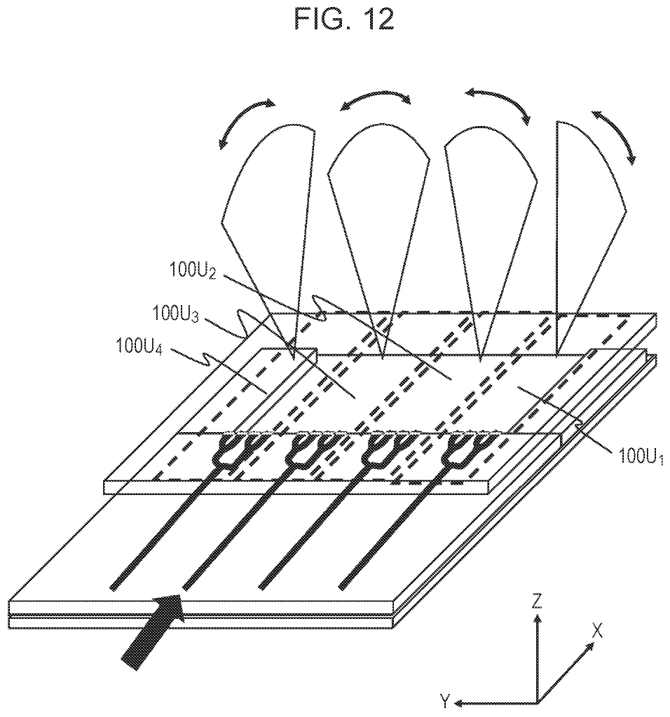

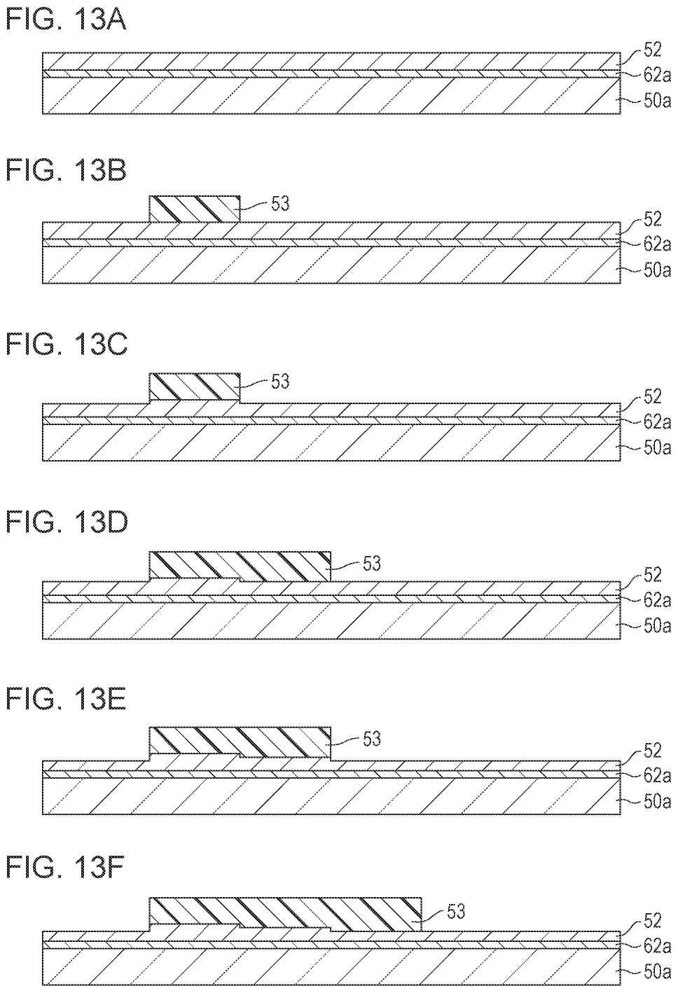

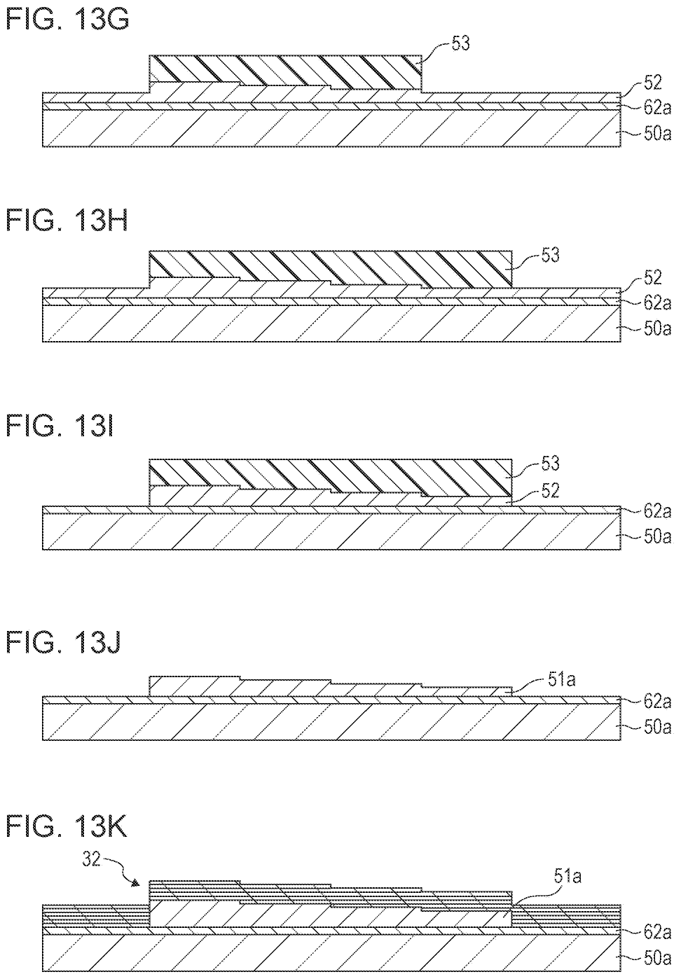

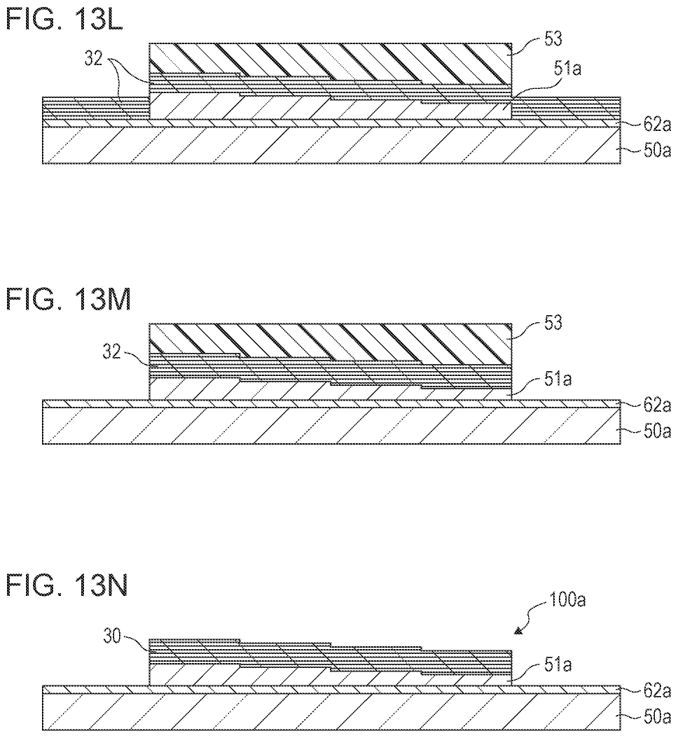

Next, an example of a manufacturing process of the upper structure 100a will be described with reference to FIGS. 13A to 13N. FIGS. 13A to 13N are diagrams for explaining an example of a manufacturing process of the upper structure 100a.

In the first step, as illustrated in FIG. 13A, films of an electrode 62a and a dielectric layer 52 are formed in this order on a substrate 50a by a sputtering method or a vapor deposition method.

In the next step, as illustrated in FIG. 13B, a photoresist pattern 53 is formed on the dielectric layer 52 by applying a photoresist and performing exposure and development with a specified pattern.

In the next step, as illustrated in FIG. 13C, the photoresist pattern 53 is used as a mask, and the portion of the dielectric layer 52 not overlapping the photoresist pattern 53 is removed by etching. The etching depth may be, for example, 75 nm or 55 nm which is the allowable range described above.

In the next step, as illustrated in FIG. 13D, the photoresist pattern 53 illustrated in FIG. 13C is peeled off, and application of a photoresist, exposure, and development are performed again to form a photoresist pattern 53 having another pattern.

In the next step, as illustrated in FIG. 13E, the photoresist pattern 53 is used as a mask, and the portion of the dielectric layer 52 not overlapping the photoresist pattern 53 is removed by etching. As a result, the portion of the dielectric layer 52 overlapping the photoresist pattern 53 has a two-stage structure.

As illustrated in FIGS. 13F to 13I, the same or similar steps are repeated on the dielectric layer 52, and the dielectric layer 52 with a four-stage structure is formed. The portion of the electrode 62a not overlapping the dielectric layer 52 is exposed. The dielectric layer 52 having a multi-step structure as above will serve as the dielectric layer 51a.

In the next step, the photoresist pattern 53 illustrated in FIG. 13I is peeled off as illustrated in FIG. 13J.

In the next step, as illustrated in FIG. 13K, a multilayer reflective film 32 is formed on the exposed portion of the electrode 62a and the dielectric layer 51a.

In the next step, as illustrated in FIG. 13L, a photoresist pattern 53 is formed on the multilayer reflective film 32 such that the photoresist pattern 53 fully overlaps the dielectric layer 51a as viewed in the direction perpendicular to the substrate 50a.

In the next step, as illustrated in FIG. 13M, the portion of the multilayer reflective film 32 not overlapping the photoresist pattern 53 is removed by etching. The portion of the multilayer reflective film 32 that was not removed serves as the mirror 30 having a multi-step structure.

In the next step, as illustrated in FIG. 13N, the photoresist pattern 53 illustrated in FIG. 13M is peeled off.

With the above steps, the upper structure 100a is manufactured.

In the foregoing example, the mirror 30 has a multi-step structure. However, the mirror 40, instead of the mirror 30, may have a multi-step structure as long as the distance between the reflecting surface 30s and the reflecting surface 40s is different for each optical waveguide unit 100U. Alternatively, both the mirrors 30 and 40 may have multi-step structures. The upper structure 100a may be manufactured in different steps other than the steps described with reference to FIGS. 13A to 13N as long as the distance between the reflecting surface 30s and the reflecting surface 40s is different for each optical waveguide unit 100U.

### Material and Dimensions of Constituents Used for Manufacturing Optical Device 100

Hereinafter, a description will be given of specific examples of the materials and dimensions of the constituents used for manufacturing the optical device 100 according to the present embodiment. In the following, dimensions in the Z direction are referred to as “thickness” or “height”.

First, specific examples of the materials and dimensions of constituents for the upper structure 100a will be described.

The substrate 50a may be formed of, for example, a SiO₂ layer. The dimensions of the substrate 50b in the X direction and the Y direction are, for example, 8 mm and 20 mm, respectively, and the thickness of the substrate 50a may be, for example, 0.7 mm.

The electrode 62a is formed of, for example, an ITO sputtering layer. The thickness of the electrode 62a may be, for example, 50 nm.

The dielectric layer 51a having the multi-step structure may be formed of, for example, a SiO₂ vapor deposition layer. The SiO₂ vapor deposition layer has a refractive index of n=1.468. In the multi-step structure, the minimum thickness of the SiO₂ vapor deposition layer is, for example, 440 μm or so, and the maximum thickness of the SiO₂ vapor deposition layer is, for example, 665 μm or so.

The mirror 30 may be a multilayer reflective film. The multilayer reflective film may be formed by stacking a Nb₂O₅ layer and a SiO₂ layer alternately by vapor deposition. The Nb₂O₅ layer has a refractive index of n=2.282. The thickness of the Nb₂O₅ layer may be, for example, 100 nm or so. The SiO₂ layer has a refractive index of n=1.468. The thickness of the SiO₂ layer may be, for example, 200 nm or so. The mirror 30 has, for example, total 13 layers: seven Nb₂O₅ layers and six SiO₂ layers. The thickness of the mirror 30 may be, for example, 1.9 μm.

Next, examples of the materials and dimensions of the constituents for the lower structure 100b will be described.

The substrate 50b may be formed of, for example, a SiO₂ layer. The dimensions of the substrate 50b in both the X direction and the Y direction may be, for example, 15 mm. The thickness of the substrate 50b may be, for example, 0.7 mm.

The electrode 62b is formed of, for example, an ITO sputtering layer. The thickness of the electrode 62b may be, for example, 50 nm.

The mirror 40 may be a multilayer reflective film. The multilayer reflective film may be formed, for example, by stacking a Nb₂O₅ layer and a SiO₂ layer alternately by vapor deposition. The Nb₂O₅ layer has a refractive index of n=2.282. The thickness of the Nb₂O₅ layer may be, for example, 100 nm or so. The SiO₂ layer has a refractive index of n=1.468. The thickness of the SiO₂ layer may be, for example, 200 nm or so. The mirror 40 has, for example, total 61 layers: 31 Nb₂O₅ layers and 30 SiO₂ layers. The thickness of the mirror 40 may be, for example, 9.1 μm.

The dielectric layer 51b may be formed of, for example, a SiO₂ vapor deposition layer. The SiO₂ vapor deposition layer has a refractive index of n=1.468. The thickness of the SiO₂ vapor deposition layer may be, for example, 1.0 μm or so.

The optical waveguides 11 may be formed of, for example, a Nb₂O₅ vapor deposition layer. The Nb₂O₅ layer has a refractive index of n=2.282. The thickness of the Nb₂O₅ layer may be, for example, 30° nm or so. The optical waveguides 11 may have the gratings 15 and the gratings 13. The grating 15 has grooves having, for example, a period of 670 nm, a duty ratio of 1:1, and a depth of 40 nm. The grating 13 has grooves having, for example, a period of 680 nm, a duty ratio of 1:1, and a depth of 40 nm. The gratings 15 and the gratings 13 may be formed by patterning using a photolithography method. The dimension of the optical waveguide 11 in the Y direction may be, for example, 10 μm.

The partition walls 73 may be formed of a SiO₂ vapor deposition layer. The SiO₂ vapor deposition layer has a refractive index of n=1.468. The thickness of the SiO₂ vapor deposition layer may be, for example, 1.0 μm. The dimension of the partition wall 73 in the Y direction may be, for example, 50 μm.

In the optical waveguide region 20, part of the dielectric layer 51b may be removed, for example, by patterning using a photolithography method. The thickness of the optical waveguide region 20 may be, for example, 2.0 μm. The dimension of the optical waveguide region 20 in the Y direction may be, for example, 10 μm.

The material for the liquid crystal material 21 may be, for example, 5CB liquid crystal.

The elastic spacers 77 may be formed of, for example, a photosensitive resin used for a photoresist material. The following describes a method of manufacturing the elastic spacers 77. A solution is prepared by diluting a photosensitive resin with an organic solvent to have a specified concentration and viscosity. The solution is applied to the dielectric layer 51b by a coating technique such as spin coating to form a solution layer having a uniform thickness on the dielectric layer 51b. The thickness of the solution layer is determined in consideration of how much the elastic spacers 77 are to be contracted when the upper structure 100a and the lower structure 100b are attached together. After the coating, pre-baking is performed to volatize the organic solvent contained in the solution layer. After that, the solution layer is exposed to light through the pattern of the elastic spacers 77 by using an exposure device such as a laser direct-writing device or a mask aligner. The unnecessary portion of the solution layer is removed by using an alkaline developer. After that, post-baking is performed to form the plurality of elastic spacers 77 having a specified height and shapes and fixed to the dielectric layer 51b.

The elastic spacer 77 may have, for example, a round pillar shape having a diameter of 30 μm or so. The plurality of elastic spacers 77 may be arranged two-dimensionally on part of the surface of the dielectric layer 51b at approximately regular intervals. The interval may be, for example, 400 μm or so. The part of the surface of the dielectric layer 51b faces the exposed portion of the electrode 62a included in the upper structure 100a. The more uniformly the plurality of elastic spacers 77 are arranged in the entire part of the surface, the more accurately the distance between the substrate 50a and the substrate 50b can be defined.

The sealing member 79 may employ, for example, UV-curing adhesive 3026E supplied by ThreeBond Co., Ltd. The sealing member 79 is provided in a specified region on the dielectric layer 51b by using, for example, a dispenser. In an example, the sealing member 79 is cured by using ultraviolet irradiation with a wavelength of 365 nm and an energy density of 100 mJ/cm², and thereby, the upper structure 100a and the lower structure 100b are attached together. With this attachment, the optical device 100 according to the present embodiment is completed.

Note that the substrates 50a and 50b may be formed of a material other than SiO₂. The substrates 50a and 50b may be, for example, inorganic substrates such as glass or sapphire or resin substrates such as acrylic or polycarbonate. These inorganic substrates and resin substrates can be used for the substrates 50a and 50b because they have light transmission properties.

The reflectance of the mirror 30 from which light is emitted is, for example, 99.9%, and the reflectance of the mirror 40 from which light is not emitted is, for example, 99.99%. These conditions can be achieved by adjusting the number of layers of the multilayer reflective film. As an example of a combination of two layers in the multilayer reflective film, the refractive index of one layer is higher than or equal to 2, and the refractive index of the other layer is lower than 2. If the difference between the two refractive indexes is large, the higher reflectance can be achieved. A layer the refractive index of which is higher than or equal to 2 is formed of, for example, at least one selected from the group consisting of SiNₓ, AlNₓ, TiOₓ, ZrOₓ (1.7≤x≤2.0), NbO_{y}, and TaO_{y} (2.2≤y≤2.5). A layer the refractive index of which is lower than 2 is formed of, for example, at least one selected from the group consisting of SiOₓ and AlOₓ.

The refractive index of the dielectric layer 51b may be, for example, lower than 2. The refractive index of each optical waveguide 11 may be, for example, higher than or equal to 2. By making the difference between the two refractive indexes sufficiently large, the evanescent light that permeates from each optical waveguide 11 into the dielectric layer 51b can be reduced.

### Modification Example

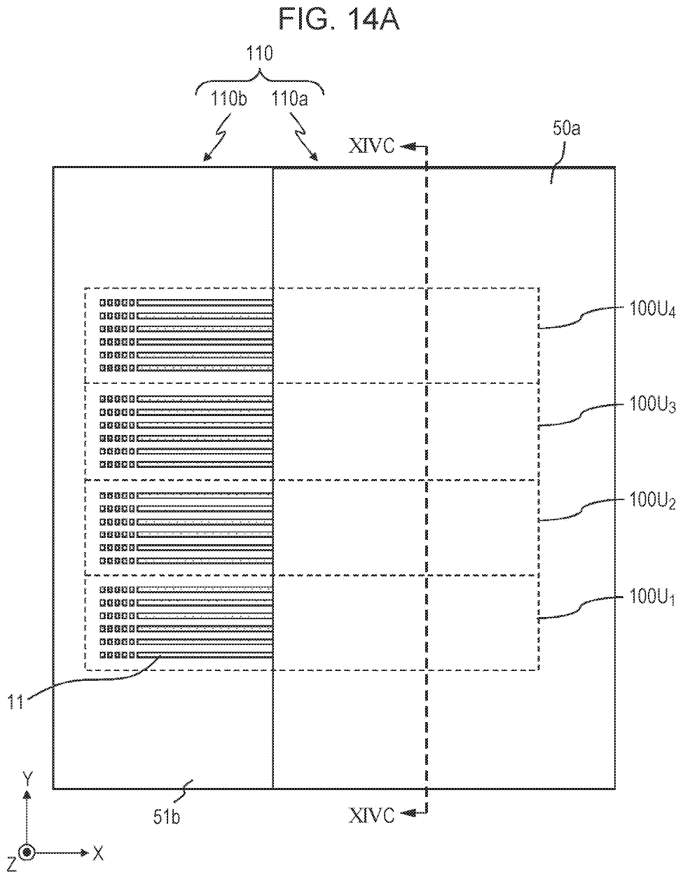

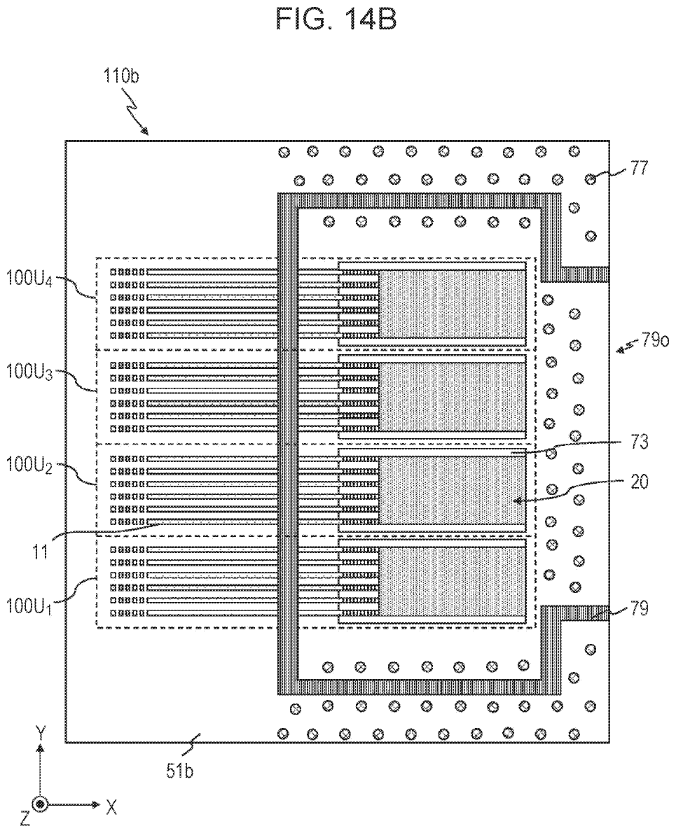

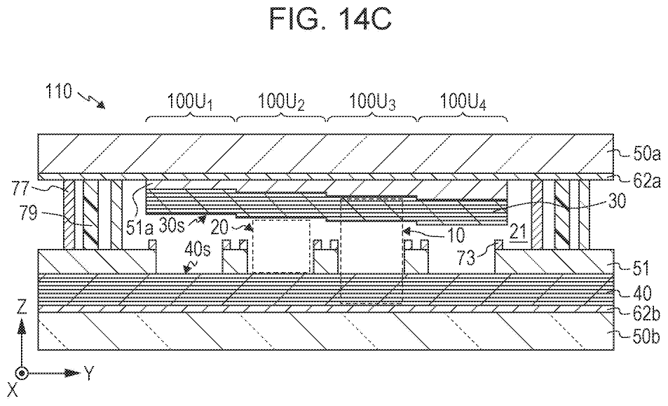

In the optical device 100 according to the present embodiment, each optical waveguide unit 100U has the plurality of optical waveguide regions 20 arranged in the Y direction. However, each optical waveguide unit 100U having a plurality of optical waveguide regions 20 is not an indispensable condition, and hence, each optical waveguide unit 100U may have one optical waveguide region 20. Such an optical waveguide region 20 may be, for example, one planar optical waveguide. In the following, an optical device 100 according to a modification example of the present embodiment will be described with reference to FIGS. 14A to 14C.

FIG. 14A is a schematic plan view of an example of an optical device 110 according to the modification example, as viewed in the Z direction. The optical device 110 according to the modification example has an upper structure 110a and a lower structure 110b. FIG. 14B is a plan view of the optical device 110 with the upper structure 110a removed from the structure illustrated in FIG. 14A. FIG. 14C is a schematic diagram illustrating the sectional structure taken along line XIVC-XIVC in FIG. 14A.

The upper structure 110a in the modification example has the same structure as the upper structure 100a in the present embodiment. In contrast, the lower structure 110b in the modification example, unlike the lower structure 100b in the present embodiment, has two partition walls 73 on either side of one optical waveguide region 20 in each optical waveguide unit 100U as illustrated in FIG. 14B. As illustrated in FIG. 14C, the lower structure 100b has a relatively wide recess in each optical waveguide unit 100U. With such a structure, the reflecting surface 40s of the mirror 40 is exposed in a relatively wide area spreading in the X direction and the Y direction. As illustrated in FIG. 14C, the recess is located between two protrusions extending in the X direction. In the example illustrated in FIG. 14C, a planar optical waveguide is formed by the reflecting surface 30s of the mirror 30, the reflecting surface 40s of the mirror 40, one optical waveguide region 20 located between the two reflecting surfaces and spreading in the X direction and the Y direction. The optical waveguide region 20 is surrounded by the reflecting surface 30s of the mirror 30, the reflecting surface 40s of the mirror 40, the two protrusions formed by the partition walls 73, and the spaces between the two protrusions and the mirror 30. The optical waveguide region 20 is filled with the liquid crystal material 21 containing a liquid crystal material.

As illustrated in FIG. 14B, a plurality of optical waveguides 11 are connected to an optical waveguide region 20 in a planar optical waveguide 10. The light propagating in the plurality of optical waveguides 11 is coupled to the optical waveguide region 20. The coupled light interferes in the optical waveguide region 20 and forms the light beam. The light beam formed in the optical waveguide region 20 is emitted to the outside via the upper structure 110a. The optical device 110 according to the modification example is also capable of changing the X-direction component and the Y-direction component of the wave vector of emitted light.

In the present embodiment and the modification example, the optical waveguide 10 is a slow light waveguide. However, the optical waveguide 10 does not have to be a slow light waveguide. For example, the optical waveguide 10 may have a configuration that does not include the mirrors 30 and 40 and in which light propagates in the optical waveguide region 20 by total reflection on the surface of the substrate 50a and the surface of the substrate 50b. The light propagating in this optical waveguide may be emitted to the outside not via the substrate 50a or the substrate 50b but from, for example, an end portion of the optical waveguide 10.

### Application Example

### Example of Application to Optical Scanning Device

FIG. 15 is a diagram illustrating a configuration example of the optical scanning device 100 in which the configuration illustrated in FIG. 11 is integrated into a circuit substrate (for example, a chip). A light source 130 may be, for example, a light emitting element such as a semiconductor laser. The light source 130 illustrated in FIG. 15 emits light having a single wavelength of λ in a free space. The light emitted from the light source 130 is selectively supplied to at least one of the first to fourth optical waveguide units 100U₁ to 100U₄ by using the optical switch 92. In the example illustrated in FIG. 15, the chip has an electrode 62A and a plurality of electrodes 62B. A waveguide array 10A receives control signals from the electrode 62A. A plurality of phase shifters 80 in a phase-shifter array 80A receive control signals via the plurality of electrodes 62B. The electrode 62A and the plurality of electrodes 62B may be connected to a control circuit (not illustrated) that generates the above control signals. The control circuit may be located on the chip illustrated in FIG. 15 or may be located on another chip included in the optical device 100.

As illustrated in FIG. 15, by integrating all the components into the chip, it is possible to achieve wide-range light scanning with a small device. For example, all the components illustrated in FIG. 15 can be integrated into a chip with a size of 2 mm×1 mm or so.

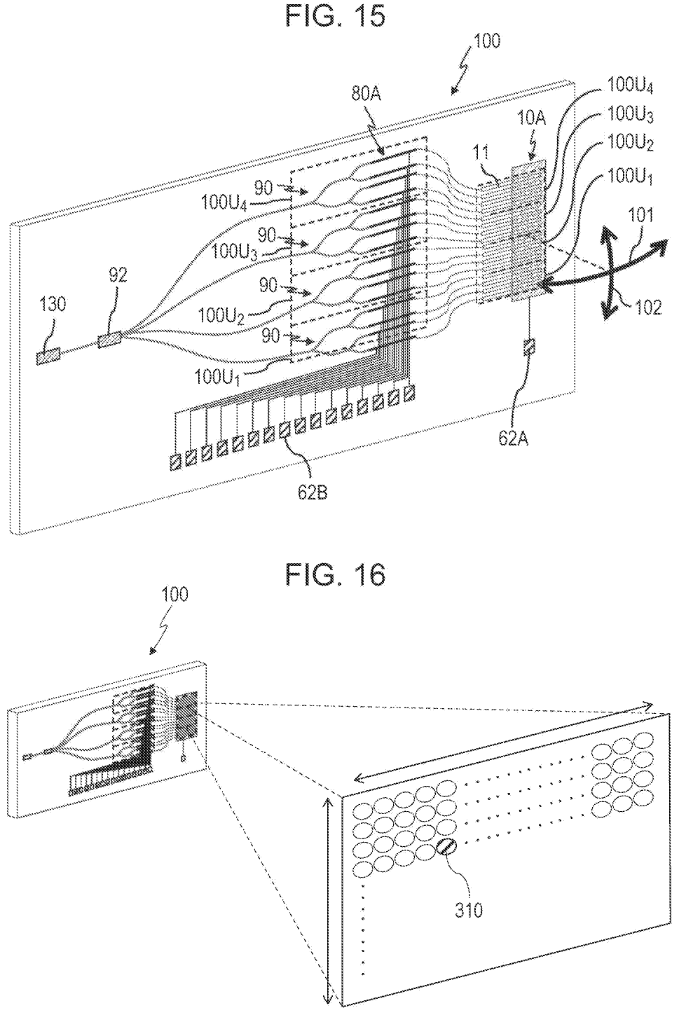

FIG. 16 is a schematic diagram illustrating the optical scanning device 100 which is emitting a light beam such as a laser to a distance to perform two-dimensional scanning. Two-dimensional scanning is performed by moving a beam spot 310 horizontally and vertically. For example, in combination with the publicly known ToF (Time of Flight) method, it is possible to obtain two-dimensional ranging images. In the ToF method, a laser is emitted to a target object, and the reflection light is measured to calculate the time of flight, from which the distance is calculated.

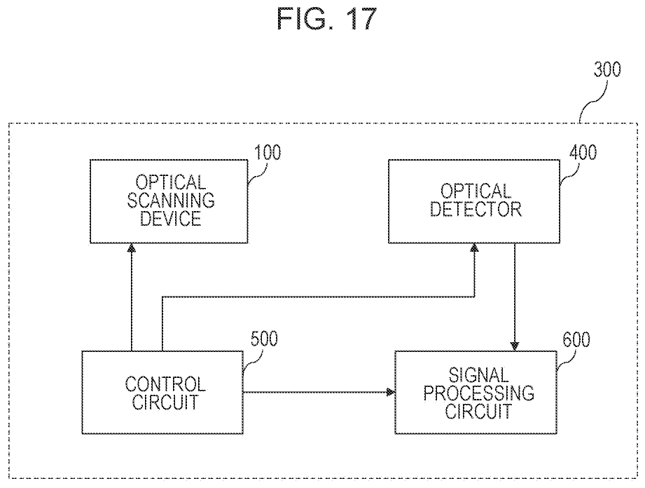

FIG. 17 is a block diagram illustrating a configuration example of a LiDAR system 300 which is an example of an optical detection system capable of generating such ranging images. The LiDAR system 300 includes an optical scanning device 100, an optical detector 400, a signal processing circuit 600, and a control circuit 500. The optical detector 400 detects light emitted from the optical scanning device 100 and reflected on a target object. The optical detector 400 may be, for example, a photo detector including a light receiving element such as an image sensor or a photo diode having a sensitivity at the wavelength λ of the light emitted from the optical scanning device 100. The optical detector 400 outputs an electrical signal according to the amount of received light. The signal processing circuit 600 calculates the distance to the target object in accordance with the electrical signal outputted from the optical detector 400 and generates distance distribution data. The distance distribution data indicates two-dimensional distribution of distances (in other words, a ranging image). The control circuit 500 is a processor that controls the optical scanning device 100, the optical detector 400, and the signal processing circuit 600. The control circuit 500 controls the time when the optical scanning device 100 is to emit a light beam, the time when the optical detector 400 is to perform exposure, and the time when signals to be read, and the control circuit 500 instructs the signal processing circuit 600 to generate ranging images.

In two-dimensional scanning, the frame rate at which a ranging image is obtained may be selected out of, for example, 60 fps, 50 fps, 30 fps, 25 fps, 24 fps, and the like which are generally used in videos. In consideration of application to an in-vehicle system, the higher the frame rate, the more frequently a ranging image can be obtained, and the more accurately obstacles can be detected. For example, during travel at 60 km/h, a frame rate of 60 fps enables an image to be obtained every time the vehicle moves approximately 28 cm. A frame rate of 120 fps enables an image to be obtained every time the vehicle moves approximately 14 cm. A frame rate of 180 fps enables an image to be obtained every time the vehicle moves approximately 9.3 cm.

The time required to obtain one ranging image is dependent on the beam scanning speed. For example, to obtain an image having 100×100 resolution points at 60 fps, the beam has to be scanned in 1.67 μs or less per point. In this case, the control circuit 500 performs control at an operation speed of 600 kHz on emission of a light beam by the optical scanning device 100 and signal accumulation and reading out by the optical detector 400.

### Example of Application to Optical Receiving Device

The optical scanning device or the optical device in each foregoing embodiment of the present disclosure can be used as an optical receiving device, with approximately the same configuration. An optical receiving device includes a waveguide array 10A which is the same as that of the optical scanning device, and a first adjustment element that adjusts the direction of receivable light. Each first mirror 30 in the waveguide array 10A enables light incident on the surface opposite to the first reflecting surface to pass through. Each optical waveguide layer 20 of the waveguide array 10A propagates the light that passed through the first mirror 30. The first adjustment element changes at least one of the refractive index of the optical waveguide layer 20, the thickness of the optical waveguide layer 20, or the wavelength of the light, in each waveguide element 10 to change the direction of receivable light taken into each optical waveguide layer 20. In the case in which the optical receiving device further includes a plurality of phase shifters 80, or 80a and 80b the same as those of the optical scanning device and a second adjustment element that changes the differences between the phases of the light outputted from the plurality of waveguide elements 10 through the plurality of phase shifters 80, or 80a and 80b, it is possible to two-dimensionally change the direction of receivable light.

For example, an optical receiving device in which the light source 130 in the optical scanning device 100 illustrated in FIG. 15 is replaced with a receiving circuit can be made. When light with a wavelength of λ is incident on the waveguide array 10A, the light is sent through the phase-shifter array 80A to the optical splitter 90, collected in the end at one place, and sent to the receiving circuit. The intensity of the light collected at the one place can be said to express the sensitivity of the optical receiving device. The sensitivity of the optical receiving device can be adjusted by using adjustment elements separately integrated in the waveguide array and the phase-shifter array 80A. In the optical receiving device, for example, the direction of the wave vector (the thick arrow in the figure) is opposite to that in FIG. 4. The incident light has a light component in the direction in which the waveguide elements 10 extend (the X direction in FIG. 4) and a light component in the arrangement direction of the waveguide elements 10 (the Y direction in FIG. 4). The sensitivity for the light component in the X direction can be adjusted by using an adjustment element integrated in the waveguide array 10A. The sensitivity for the light component in the arrangement direction of the waveguide elements 10 can be adjusted by using an adjustment element integrated in the phase-shifter array 80A. From the phase difference Δφ of light, the refractive index n_{w} of the optical waveguide layer 20, and the thickness d of the optical waveguide layer 20 at the time when the sensitivity of the optical receiving device is at maximum, θ and α₀ illustrated in FIG. 4 can be determined. From these results, the incident direction of the light can be determined.

The optical scanning device and the optical receiving device in the embodiment of the present disclosure can be applied to, for example, a LiDAR system or the like mounted in vehicles such as automobiles, UAVs, and AGVs.

What is claimed is:

1. An optical device comprising a plurality of optical waveguide units arranged in a first direction, wherein
each of the optical waveguide units includes
a first mirror having a first reflecting surface,
a second mirror having a second reflecting surface facing the first reflecting surface, and
at least one optical waveguide region located between the first mirror and the second mirror, and
a distance between the first reflecting surface and the second reflecting surface is different for each of the optical waveguide units.

2. The optical device according to claim 1, wherein
at least one of the optical waveguide units includes at least one optical input waveguide that is optically connected to the optical waveguide region and that inputs light to the optical waveguide region.

3. The optical device according to claim 2, wherein
the optical input waveguide is connected to the optical waveguide region via a mode converter.

4. The optical device according to claim 3, wherein
the mode converter includes a grating, and
the grating has a structure a refractive index of which varies periodically along a second direction intersecting the first direction.

5. The optical device according to claim 3, wherein
an efficiency in optical coupling from the optical input waveguide in the at least one of the optical waveguide units to the optical waveguide region via the mode converter is higher than or equal to 80%.

6. The optical device according to claim 5, wherein
an efficiency in optical coupling in an optical waveguide unit adjoining the at least one of the optical waveguide units is lower than 80%.

7. The optical device according to claim 1, wherein
the distance between the first reflecting surface and the second reflecting surface varies monotonously along the first direction.

8. The optical device according to claim 7, wherein
the distance between the first reflecting surface and the second reflecting surface varies in regular steps along the first direction.

9. The optical device according to claim 1, wherein
the first mirror has a higher transmittance than the second mirror.

10. The optical device according to claim 9, wherein
each of the optical waveguide units includes
a first electrode and a second electrode, and
a liquid crystal material between the first mirror and the second mirror,
the optical waveguide region is filled with the liquid crystal material, and
a voltage applied between the first electrode and the second electrode is changed to change a direction of light emitted from the optical waveguide region via the first mirror or an incident direction of light taken into the optical waveguide region via the first mirror.

11. The optical device according to claim 1, further comprising:
a first structure including the first mirror included in each of the optical waveguide units;
a second structure including the second mirror included in each of the optical waveguide units; and
at least one support member that is located between the first structure and the second structure and defines the distance between the first reflecting surface and the second reflecting surface.

12. The optical device according to claim 11, wherein
the support member is formed of an elastic material.

13. The optical device according to claim 1, further comprising
an optical switch capable of selectively supplying light to the optical waveguide region included in at least one of the optical waveguide units.

14. The optical device according to claim 1, wherein
of the plurality of optical waveguide units, only part of the optical waveguide units are supplied with light and other optical waveguide units are not supplied with light.

15. The optical device according to claim 14, wherein
an efficiency in optical coupling to the optical waveguide region in the part of the optical waveguide units is higher than or equal to 80%.

16. An optical detection system comprising:
the optical device according to claim 1;
an optical detector that detects light emitted from the optical device and reflected on a target object; and
a signal processing circuit that generates distance distribution data, according to output from the optical detector.
